(19) United States
(12) Patent Application Publication
(10) Pub. No.: US 2024/0104474 A1
(43) Pub. Date: Mar. 28, 2024

(54) METHODS, SYSTEMS, AND DEVICES FOR MANAGING USER VEHICULAR OPERATION, ACTIVITY, AND SAFETY

(71) Applicant: MAXIS BROADBAND SDN. BHD., Kuala Lumpur (MY)

(72) Inventors: Boon Ong Lee, Kuala Lumpur (MY); Chithiramanaalan Raman, Kuala Lumpur (MY); Mohd Helmi Kamaludin, Kuala Lumpur (MY)

(73) Assignee: MAXIS BROADBAND SDN. BHD., Kuala Lumpur (MY)

(21) Appl. No.: 18/003,089

(22) PCT Filed: Jul. 30, 2021
(86) PCT No.: PCT/MY2021/050064

§ 371 Date: Dec. 22, 2022

(51) Int. Cl. G06Q 10/0635; G06Q 10/0639; G06Q 50/40

(52) U.S. Cl. CPC G06Q 10/0635; G06Q 10/0639; G06Q 50/40

(57) ABSTRACT

Embodiments relate to methods, systems, and devices for managing vehicular operational risks. The method includes receiving a pre-journey information set for a journey. The pre-journey information set includes a start time and a pre-journey device activity information set. The pre-journey device activity information set includes information on usage of a mobile device by a user before the start time. The method includes generating an in-journey information set. The in-journey information set includes an in-journey duration information set. The in-journey duration information set includes an amount of time since the start time, estimated remaining time for the journey, and/or estimated duration for the journey. The method includes generating a user operation score. The user operation score represents vehicular operational risks. The user operation score is generated based on at least the pre-journey device activity information set and in-journey duration information set.

### TECHNICAL FIELD

The present disclosure relates generally to managing the operation of vehicles, and more specifically, to methods, systems, and devices for managing user vehicular operation, activity, and safety.

### BACKGROUND

Businesses around the world routinely deploy personnel to operate a variety of vehicles for a variety of tasks. For example, businesses deploy personnel to operate cars, trucks, special purpose vehicles, other land-based vehicles, boats, other water-based vehicles, airplanes, other air-based vehicles, etc. to travel from a first location to one or more other locations for a variety of reasons, including the delivering of items and/or passengers, performing of inspections at one or more destinations and/or along one or more routes, attending of meeting, providing of on-site services, etc.

### BRIEF SUMMARY

While the deploying of personnel to operate vehicles are common and oftentimes required activities for many businesses, it is recognized in the present disclosure that several problems may arise during such work and at various work sites. As a non-limiting example, personnel may become fatigued prior to and/or during such operating of vehicles. As another example, personnel may become distracted during such operating of vehicles. As another example, personnel may become exposed to dangerous situations, such as situations when personnel are exposed to carbon monoxide (and/or other gases) poisoning in the vehicle. In yet another example, personnel may be improperly, inefficiently, and/or ineffectively operating vehicles. In each of the aforementioned example situations (and other high risk and/or dangerous situations contemplated, but not described, in the present disclosure), the personnel and/or others (e.g., team members, supervisors, control centers for the business, authorities, etc.) are generally unable to accurately, effectively, and/or efficiently monitor, identify, detect, be notified of, react to, and/or assist, in real time or near real-time, the personnel and/or the vehicle (each as applicable). In this regard, the personnel and/or others (e.g., team members, supervisors, control centers, authorities, etc.) may only identify, realize, and/or learn of such situations when it is already too late (e.g., an accident occurs).

Present example embodiments relate generally to and/or include systems, subsystems, processors, devices, logic, methods, and processes for addressing conventional problems, including those described above and in the present disclosure, and more specifically, example embodiments relate to systems, subsystems, processors, devices, logic, methods, and processes for managing the operation, activity, and/or safety of vehicles operated by users.

In an exemplary embodiment, a method of managing vehicular operational risks is described. The method includes receiving, by a processor from a mobile device of a first user, a pre-journey information set (and/or pre-journey information) for a first journey of the first user. The pre-journey information set includes a start time for the first journey and a pre-journey device activity information set. The pre-journey device activity information set includes information on usage of the mobile device by the first user during a first time period immediately preceding the start time. The method also includes generating, by the processor, an in-journey information set. Alternatively or in addition, the method may include receiving, by the processor, in-journey information and/or one or more in-journey information sets. The in-journey information set includes information received, by the processor from the mobile device, at a first time. The first time is a time after the start time. The in-journey information set includes an in-journey duration information set. The in-journey duration information set includes one or more of the following: an amount of time between the start time and the first time, estimated remaining time for the first journey as of the first time, and/or estimated duration for the first journey. The estimated duration for the first journey includes an estimated total travel time for the first journey. The method further includes generating, by the processor, a user operation score for the first user for the first time. The user operation score represents vehicular operational risks of the first user for the first journey as of the first time. The user operation score is generated based on at least the pre-journey device activity information set and the in-journey duration information set.

In another exemplary embodiment, a method of managing vehicular operational risks is described. The method includes receiving, by a processor from a mobile device of a first user, a pre-journey information set (and/or pre-journey information) for a first journey of the first user. The pre-journey information set includes information received by the processor before the start time. The pre-journey information set includes a start time for the first journey. The pre-journey information set also includes a pre-journey geolocation information set. The pre-journey geolocation information set includes a pre-journey estimated distance for the first journey and pre-journey route information for the first journey. The pre-journey information set also includes a pre-journey duration information set. The pre-journey duration information set includes an estimated total travel time for the first journey. The pre-journey information set also includes a pre-journey device activity information set. The pre-journey device activity information set includes information on mobile device usage by the first user during a first time period immediately preceding the start time. The method also includes generating, by the processor, a user operation score for the first user for the start time. The user operation score represents vehicular operational risks of the first user for the first journey as of the start time. The user operation score is generated based on at least the pre-journey geolocation information set, the pre-journey duration information set, and the pre-journey device activity information set.

In another exemplary embodiment, a method of managing vehicular operational risks is described. The method includes receiving, by a processor from a mobile device of a first user, a pre-journey information set (and/or pre-journey information) for a first journey of the first user. The pre-journey information set includes information received by the processor before the start time. The pre-journey information set includes a start time for the first journey. The pre-journey information set also includes a pre-journey geolocation information set. The pre-journey geolocation information set includes a pre-journey estimated distance for the first journey and pre-journey route information for the first journey. The pre-journey information set also includes a pre-journey duration information set. The pre-journey duration information set includes an estimated total travel time for the first journey. The pre-journey information set also includes a pre-journey device activity information set. The pre-journey device activity information set includes information on mobile device usage by the first user during a first time period immediately preceding the start time. The method also includes generating, by the processor, an in-journey information set. Alternatively or in addition, the method may include receiving, by the processor, in journey information and/or one or more in journey information sets. The in journey information set includes information received, by the processor from the mobile device, at a first time. The first time is a time after the start time. The in-journey information set includes an in journey geolocation information set. The in journey geolocation information set includes an in journey present location information, in journey estimated distance for the first journey, and/or in journey route information for the first journey. The in-journey estimated distance for the first journey includes an update to the pre-journey estimated distance for the first journey as of the first time. The in journey present location information includes geolocation information of the mobile device as of the first time. The in journey route information includes an update to the pre-journey route information for the first journey as of the first time. The in journey information set also includes an in journey duration information set. The in journey duration information set includes one or more of the following: an in-journey amount of time between the start time and the first time, in-journey estimated remaining time for the first journey as of the first time, and/or in estimated duration for the first journey. The in estimated duration for the first journey includes an update to the pre-journey duration information set as of the first time. The in journey information set also includes an in-journey device activity information set. The in-journey device activity information set includes information on usage of the mobile device by the first user between the start time and the first time. The in journey information set also includes an in journey rest information set. The in journey rest information set includes rest recommendations for the first user during the first journey based on at least one or more of the following: the in journey present location information, the in journey estimated distance for the first journey, the in journey route information for the first journey, the in journey duration information set, and/or the in journey device activity information set. The method also includes generating, by the processor, a user operation score for the first user for the first time. The user operation score represents vehicular operational risks of the first user for the first journey as of the first time. The user operation score is generated based on at least the in journey geolocation information set, the in journey duration information set, the in journey device activity information set, and the in journey rest information set.

In another exemplary embodiment, a method of managing vehicular operational risks is described. The method includes receiving, by a processor from a mobile device of a first user, a start time for a first journey of the first user. The method also includes generating, by the processor, an in-journey information set. Alternatively or in addition, the method may include receiving, by the processor, in-journey information and/or one or more in-journey information sets. The in-journey information set includes information received, by the processor from the mobile device, at a first time. The first time is a time after the start time. The in-journey information set includes an in-journey geolocation information set. The in-journey geolocation information set includes an in-journey present location information, in-journey estimated distance for the first journey, and/or in-journey route information for the first journey. The in-journey present location information includes geolocation information of the mobile device as of the first time. The in information set also includes an in duration information set. The in-journey duration information set includes one or more of the following: an in-journey amount of time between the start time and the first time, in-journey estimated remaining time for the first journey as of the first time, and/or in estimated duration for the first journey. The in estimated duration for the first journey includes an estimated total travel time for the first journey. The in-journey information set also includes an in-journey device activity information set. The in-journey device activity information set includes information on usage of the mobile device by the first user between the start time and the first time. The in-journey information set also includes an in-journey rest information set. The in-journey rest information set includes rest recommendations for the first user during the first journey based on at least one or more of the following: the in-journey present location information, the in-journey estimated distance for the first journey, the in-journey route information for the first journey, the in-journey duration information set, and/or the in-journey device activity information set. The method also includes generating, by the processor, a user operation score for the first user for the first time. The user operation score represents vehicular operational risks of the first user for the first journey as of the first time. The user operation score is generated based on at least the in-journey geolocation information set, the in-journey duration information set, the in-journey device activity information set, and the in-journey rest information set.

### BRIEF DESCRIPTION OF THE FIGURES

For a more complete understanding of the present disclosure, example embodiments, and their advantages, reference is now made to the following description taken in conjunction with the accompanying figures, in which like reference numbers indicate like features, and:

FIG. 1 is an illustration of an example embodiment of a system for managing vehicular operational risks;

FIG. 2 is an illustration of an example embodiment of a processor for managing vehicular operational risks;

FIG. 3 is an illustration of an example embodiment of a pre-journey processor;

FIG. 4 is an illustration of an example embodiment of an in-journey processor;

FIG. 5 is an illustration of an example embodiment of a method of managing vehicular operational risks; and

FIG. 6 is an illustration of another example embodiment of a method of managing vehicular operational risks.

Although similar reference numbers may be used to refer to similar elements in the figures for convenience, it can be appreciated that each of the various example embodiments may be considered to be distinct variations.

Example embodiments will now be described with reference to the accompanying figures, which form a part of the present disclosure and which illustrate example embodiments which may be practiced. As used in the present disclosure and the appended claims, the terms “embodiment”, “example embodiment”, “exemplary embodiment”, and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on”, and the terms “a”, “an”, and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

### DETAILED DESCRIPTION

Present example embodiments relate generally to and/or include, among other things, systems, subsystems, processors, devices, logic, methods, and processes for addressing conventional problems, including those described above and in the present disclosure, and more specifically, example embodiments relate to systems, subsystems, processors, devices, logic, methods, and processes for managing users' operation of vehicles.

As a non-limiting example, present example embodiments are directed to managing, improving, and/or assuring the safety, reliability, efficiency, effectiveness, and/or accountability of the operation of vehicles (i.e., by users) before, during, throughout, and/or after a journey. As used in the present disclosure, a “journey” may include, but is not limited to, any trip, assignment, route, drive, delivery, journey, and/or the like, by a user operating a vehicle (e.g., delivering a parcel; inspecting a facility; picking up and dropping off passengers along a fixed or unfixed route; etc.). A journey includes a starting point (or starting location, starting geolocation, etc.), a starting time (or starting date, starting date/time, starting timestamp, etc.), while ending the journey, an ending point (or ending location, ending geolocation, etc.), and an ending time (or ending date, ending date/time, ending timestamp, etc.). In some example embodiments, a journey may also include one or more intermediate stopping points (or stopping locations, stopping geolocations, rest stops, etc.) between the starting point and the ending point; and/or one or more intermediate stopping time (or intermediate stopping date, intermediate stopping date/time, intermediate stopping timestamp, rest stop time, etc.) between the starting time and the ending time. The ending point and/or ending time may be predetermined for a journey (e.g., for fixed routes and/or already set journeys) or dynamically determined for a journey (e.g., for non-fixed routes, new journeys, changes to predetermined journeys, changes to dynamically determined journeys, etc.). A journey may also include one or more possible routes (e.g., fastest route, alternative route(s), route with least distance travelled, most congested route, least congested route, etc.), travel distances (e.g., in kilometers or miles), travel times (e.g., in minutes, hours, days, etc.), and/or travel conditions (e.g., traffic, environmental conditions, construction, special events, etc.).

Example embodiments are configurable or configured to perform such managing, improving, and/or assuring of the safety, reliability, efficiency, effectiveness, and/or accountability of a user's operation of a vehicle before, during, throughout, and/or after a journey by, among other things, assessing (prior to, during, throughout, and/or after the journey) whether the user is, will be, and/or was (each as applicable) in a condition to safely, reliably, efficiently, and/or effectively operate the vehicle for the journey. Such assessing may be performing based on a variety of actions, methods, and/or processes.

For example, example embodiments are configurable or configured to receive, obtain, and/or generate information pertaining to a user, mobile device of a user, and/or vehicle for a journey prior to and/or leading up to the start of the journey (e.g., pre-journey information or pre-journey information sets, as described in the present disclosure), which may include, but are not limited to the following information: a start time for the journey; and/or estimated distance for the journey, route information for the journey, etc., as estimated before the start of the journey (e.g., pre-journey geolocation information or pre-journey geolocation information set, as further described in the present disclosure); and/or estimated total travel time for the journey, as estimated before the start of the journey (e.g., pre-journey duration information or pre-journey duration information set, as further described in the present disclosure); and/or information on usage of the user's mobile device before the user starts operating the vehicle for the journey, such as duration of usage, types of apps used, user interactions with the mobile device, network activity, amount of data transmitted/received, etc. (e.g., pre-journey device activity information or pre-journey device activity information set, as further described in the present disclosure); and/or the user's biometric information/readings before the user starts to operate the vehicle for the journey (e.g., pre-journey biometric information or pre-journey biometric information set, as further described in the present disclosure); and/or information pertaining to a hazardous gas level (and/or hazardous level of gas) within the vehicle before the user starts operating the vehicle for the journey (e.g., pre-journey hazardous gas information or pre-journey hazardous gas information set, as further described in the present disclosure); and/or historic information (e.g., the user's history, experience, and/or performance with operating a vehicle: for similar or same journey; at a time of the day corresponding to the start time; on a day of the week corresponding to the day of the journey; on a day of the month corresponding to the day of the journey; after similar or same mobile device usage before starting operation of a vehicle; with similar or same biometric information/readings before starting operation of a vehicle).

Example embodiments are also configurable or configured to receive, obtain, and/or generate information pertaining to the user, mobile device of the user, and/or vehicle for the journey at one or more times during the journey, such as a first time (which is a time after the start time) (e.g., in-journey information or in-journey information set, as further described in the present disclosure). Such in-journey information may include, but are not limited to, the following information: an amount of time between the start time and the first time; and/or estimated remaining time for the journey as of the first time; and/or estimated duration for the journey (including an estimated total travel time for the journey), as estimated as of the first time, etc. (e.g., in-journey duration information or in-journey duration information set, as further described in the present disclosure); and/or any particular time (e.g., the first time) when example embodiments performs an action, a time of the day, a day of the week, a day of the month, etc. (e.g., in-journey temporal information or in-journey temporal information set, as further described in the present disclosure); present location information as of the first time (including geolocation information of the mobile device as of the first time); and/or estimated distance for the journey estimated as of the first time (including an estimated total distance for the journey as of the first time); and/or route information for the journey as of the first time, etc. (e.g., in-journey geolocation information or in-journey geolocation information set, as further described in the present disclosure); and/or information on usage of the mobile device by the user between the start time and the first time (e.g., in-journey device activity information or in-journey device activity information set, as further described in the present disclosure); and/or real-time biometric information of the first user as of the first time; and/or biometric information of the first user obtained between the start time and the first time, etc. (e.g., in-journey biometric information or in-journey biometric information set, as further described in the present disclosure); and/or real-time weather conditions; and/or real-time traffic conditions; and/or weather conditions between the start time and the first time; and/or traffic conditions between the start time and the first time; and/or weather condition forecasts for the rest of the first journey; and/or traffic condition forecasts for the rest of the first journey, etc. (e.g., in journey environmental information or in-journey environmental information set, as further described in the present disclosure); and/or rest times, frequencies, and/or recommendations during the journey, as estimated as of the first time, based on information described above and in the present disclosure (e.g., in-journey rest information or in-journey rest information set, as further described in the present disclosure); and/or real-time information pertaining to a hazardous gas level (or hazardous level of gas) within the vehicle obtained between the start time and the first time (e.g., in-journey hazardous gas information or in-journey hazardous gas information set, as further described in the present disclosure); and/or real-time information pertaining to fuel consumption of the vehicle obtained between the start time and the first time (e.g., in-journey fuel consumption information or in-journey fuel consumption information set, as further described in the present disclosure).

Example embodiments are further configurable or configured to generate a user operation score, or the like, for the user for the journey (e.g., a pre-journey user operation score, an in-journey user operation score, a user operation score). The user operation score represents, among other things, vehicular operation risks for the user for the journey as of a particular time (e.g., before the journey starts, at a first time between the start time and the end time, etc.). The user operation score is generated based on pre-journey information, pre-journey information sets, in-journey information, and/or in-journey information sets, as described above and in the present disclosure.

Example embodiments are also configurable or configured to determine how each user is operating a vehicle by comparing the user operation score for the user with one or more threshold operation scores (which are predetermined and/or dynamically generated). When example embodiments determine that the user operation score for the user is less than or equal to one or more threshold operation scores, example embodiments are configurable or configured to generate a response. For example, example embodiments may perform, among other things, one or more of the following: sending of a notification to the user to stop vehicular operations; sending of a notification to the user to rest; sending of a notification to an authority (e.g., control center, command center, supervisor, headquarter, police or other law enforcement, traffic authorities, etc.) regarding potentially unsafe vehicular operations by the user of the vehicle; sending of a command to remotely control (e.g., speed, direction, etc. of the vehicle; audio device of the vehicle; roll down one or more windows of the vehicle; etc.), automatically control (e.g., autonomous vehicle mode or semi-autonomous vehicle mode), limit the control of, and/or shut down the vehicle that is being operated by the user; and/or sending a command to remotely control, automatically control, limit the control of, and/or shut down the mobile device of the user.

It is to be understood in the present disclosure that one or more elements, actions, and/or aspects of example embodiments may include and/or implement, in part or in whole, solely and/or in cooperation with other elements, using, for example, networking technologies, cloud computing, distributed ledger technology (DLT) (e.g., blockchain), artificial intelligence (AI), machine learning, deep learning, etc. Furthermore, although example embodiments described in the present disclosure may be directed to the operation of motor vehicles (e.g., cars, trucks, etc.), it is to be understood in the present disclosure that example embodiments may also be directed to the operation of other types or forms of vehicles (e.g., electric vehicles (EV), semi-autonomous vehicles, construction vehicles, special purpose vehicles, trains, other land transport vehicles, water transport vehicles (e.g., boats), air transport vehicles (e.g., airplanes, helicopters, etc.), etc.) (referred to herein as a “vehicle”) without departing from the teachings of the present disclosure.

Example embodiments will now be described below with reference to the accompanying figures, which form a part of the present disclosure.

### Example Embodiments of a System for Managing User Vehicular Operation, Activity, and/or Safety (e.g., System 100)

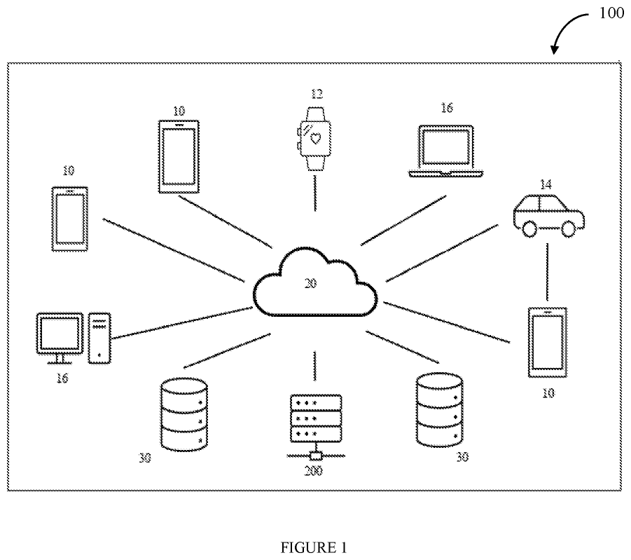

FIG. 1 illustrates an example embodiment of a system (e.g., system 100) for managing, improving, and/or assuring the safety, reliability, efficiency, effectiveness, and/or accountability of the operation of vehicles (i.e., by users) before, during, throughout, and/or after a journey. As described in the present disclosure, the system 100 is configurable or configured to do so by performing one or more of a variety of functions, actions, and/or processes.

For example, the system 100 is configurable or configured to perform, among other things, one or more of the following when a user 10 is operating a vehicle 14 (i.e., during and/or throughout a journey, or “in-journey”): tracking, monitoring, managing, reviewing, assessing, analyzing, processing, identifying, authorizing, unauthorizing, flagging, warning, notifying, quantifying, qualifying, scoring, rating, ranking, storing, sharing, and/or reporting of, among other things: the user's 10 operations (and/or lack of operation, as applicable) of the vehicle 14 during the journey; the user's 10 activities (and/or lack of activities, as applicable) during the journey; the user's 10 actions (and/or lack of actions, as applicable) during the journey; the user's device 10 usage (and/or lack of usage, as applicable) during the journey; and/or the user's 10 condition (e.g., biometrics) during the journey.

The system 100 is also configurable or configured to perform, among other things, one or more of the following prior to and/or leading up to a user 10 starting/commencing on a journey (e.g., prior to commencing operation of a vehicle 14, or “pre-journey”): tracking, monitoring, managing, reviewing, assessing, analyzing, processing, identifying, flagging, warning, notifying, quantifying, qualifying, scoring, rating, ranking, storing, sharing, and/or reporting of, among other things: the user's 10 activities (and/or lack of activities, as applicable) prior to and/or leading up to commencement of the journey; the user's 10 actions (and/or lack of actions, as applicable) prior to and/or leading up to commencement of the journey; the user's 10 device 10 usage (and/or lack of usage, as applicable) prior to and/or leading up to commencement of the journey; and/or the user's 10 condition (e.g., biometrics) prior to and/or leading up to commencement of the journey.

Based on the actions described above and in the present disclosure, the system 100 can determine, among other things: how the user 10 has been and/or is currently operating the vehicle 14 (e.g., whether or not the user 10 has been and/or is currently operating the vehicle 14 in a safe, proper, efficient, and/or normal manner; e.g., via a user operation score); how the user previously operated the vehicle 14 (and/or another vehicle 14) (e.g., whether or not the user previously operated the vehicle 14 (and/or another vehicle 14) in a safe, proper, efficient, and/or normal manner; e.g., via a user operation score for a previous time or period during the journey; e.g., via a user operation score for a previous journey; e.g., via a user operation score for a previous vehicle 14); whether or not the user 10 should improve his/her operation of the vehicle 14 (and/or other vehicles 14 in future journeys) to be in a more safe, proper, efficient, and/or normal manner (including how the user 10 should improve his/her operation of the vehicle 14 (and/or other vehicles 14 in future journeys); e.g., via a user operation score); whether or not the user 10 should take a break from operating the vehicle 14 (e.g., when the system 100 determines that the user 10 may be tired, may require rest, may have been operating the vehicle 14 for too long of a duration and/or too far of a distance, etc.); and/or whether or not the user 10 should stop operation of the vehicle 14 because the user 10 has been and/or is currently operating the vehicle 14 in an unsafe, improper, inefficient, and/or otherwise abnormal manner (e.g., via sending of a message or notice to the user 10 and/or user device 10; via disabling of the vehicle 14 during the journey; and/or via sending of a message or notice to one or more authorities (not shown), such as an employer/manager/supervisor of the user 14, roadside assistance-related authorities, law enforcement authorities, etc.).

In example embodiments when the system 100 determines that a user 10 is operating a vehicle 14 (e.g., during a journey) in an unsafe, improper, inefficient, and/or otherwise abnormal manner, the system 100 is configurable or configured to perform, among other things, one or more of the following: preventing the user's 10 operation of the vehicle 14 and/or user device during the journey; controlling the user's 10 operation of the vehicle 14 and/or user device during the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.); revoking authorization of the user's 10 operation of the vehicle 14 and/or user device 10 during the journey. Similarly, in situations where the system 100 determines there is a likelihood (e.g., greater than a predetermined or dynamically determined threshold value) that a user 10 is unable and/or will not be able to operate a vehicle 14 (either for a part of or the entire journey) in a safe, proper, efficient, and/or normal manner, the system 100 is also configurable or configured to perform, among other things, one or more of the following: preventing the user's 10 operation of the vehicle 14 and/or user device 10 prior to the journey; controlling the user's 10 operation of the vehicle 14 and/or user device 10 prior to the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.), and/or revoking authorization of the user's 10 operation of the vehicle 14 and/or user device 10 prior to the journey.

To perform one or more of the functions, actions, and/or processes described above and in the present disclosure, the system 100 receives, requests, and/or obtains information from one or more information sources (e.g., users 10, user devices 10, wearable devices 12, user vehicles 14, control centers 16, communication channels 20, databases 30, processors 200, authorities (not shown), etc.; referred to individually or collectively herein as an “information source”; each as applicable). For example, the system 100 may receive, request, and/or obtain information from one or more information sources in real-time and/or near real-time. Alternatively or in addition, the system 100 may receive, request, and/or obtain information from one or more information sources in a periodic, intermittent, or sporadic manner (e.g., every seconds, 10 seconds, 15 seconds, 30 seconds, 1 minute, etc.). Alternatively or in addition, the system 100 may receive, request, and/or obtain information from one or more information sources upon the occurrence (and/or non-occurrence) of an event, action, condition, receipt of certain information, etc. (e.g., movement and/or change of geolocation of the user 10, user device 10, and/or vehicle 14; non-movement or no change of geolocation of the user 10, user device 10, and/or vehicle 14; sudden, unexpected, unplanned, unscheduled, unpredicted, and/or abnormal change in speed, direction, and/or position; deviation from the expected, predicted, scheduled, planned, and/or assigned route for the journey; sudden, unexpected, unplanned, unscheduled, unpredicted, and/or abnormal change in user device 10 usage, activity, and/or movement; sudden, unexpected, unplanned, unscheduled, unpredicted, and/or abnormal change in biometric readings (e.g., when a user 10 is wearing a wearable device 10 that is in communication with the user device 10); sudden, unexpected, unplanned, unscheduled, unpredicted, and/or abnormal change in carbon monoxide or other gas level in the vehicle of the user 10; etc.). Alternatively or in addition, the system 100 may receive, request, and/or obtain historic information of the user 10, user device 10, vehicle 14, route for the journey, weather and/or environmental conditions, etc. from one or more information sources. Alternatively or in addition, the system 100 may receive, request, and/or obtain benchmark, average, model (or ideal), standard, and/or threshold (predetermined and/or dynamically determined) information from one or more such information sources.

When the system 100 receives information from one or more information sources, the system 100 is configurable or configured to process the information so as to, among other things, track, monitor, manage, review, assess, analyze, process, identify, authorize, unauthorize, flag, warn, notify, prevent, disable, quantify, qualify, score, rate, rank, store, share, report, and/or control (referred to individually or collectively herein as “manage”; each as applicable) a user's current operation, past/historic operation(s), and/or proposed, scheduled, assigned, and/or upcoming operation of a vehicle 14 (and/or user device 10) for a predefined (or not predefined) journey.

The system 100 performs such processing of information to manage user 10 vehicular operations for a journey via one or more processors (e.g., processor 200). Each processor 200 is configurable or configured to connect to, communicate with, manage, and/or receive communications from one or more users 10, one or more user devices 10, one or more wearable devices 12, one or more user vehicles 14, one or more control centers 16, one or more communication channels 20, one or more databases 30, and/or one or more other processors 200. The system 100 also includes and/or communicates with one or more networks, communication channels, or the like (e.g., communication channels 20), which are used to enable communications between elements of the system 100. The system 100 also includes and/or communicates with one or more databases, distributed ledgers, or the like (e.g., database 30) for storing of information. The system 100 also includes and/or communicates with one or more users and/or user devices (e.g., user 10, user device 10; user 10 and user device 10 may be interchangeably used in the present disclosure). The system 100 also includes and/or communicates with one or more user wearable devices (e.g., wearable device 12). The system 100 also includes and/or communicates with one or more user vehicles (e.g., user vehicles 14). The system 100 also includes and/or communicates with one or more control centers (e.g., control center 16). Although the figures may illustrate the system 100 as having one processor 200, one communication channel 20, one database 30, three user devices 10, one wearable device 12, one user vehicle 14, and two control centers 16, it is to be understood that the system 100 may include more than one processor 200, more than one communication channel 20, more than one database 30, more or less than three user devices 10, more than one wearable device 12, more than one user vehicle 14, and more or less than two control centers 16 without departing from the teachings of the present disclosure.

As used in the present disclosure, when applicable, a reference to a system (e.g., system 100) or processor (e.g., processor 200) may also refer to, apply to, and/or include one or more computing devices, processors, servers, systems, cloud-based computing, or the like, and/or functionality of one or more processors, computing devices, servers, systems, cloud-based computing, or the like. The system 100 and/or processor 200 (and/or its elements, as described in the present disclosure) may be any processor, server, system, device, computing device, controller, microprocessor, microcontroller, microchip, semiconductor device, or the like, configurable or configured to perform, among other things, a processing and/or managing of information, searching for information, identifying of information, data communications, and/or any one or more other actions described above and in the present disclosure. Alternatively, or in addition, the system 100 and/or processor 200 (and/or its elements, as described in the present disclosure) may include and/or be a part of a virtual machine, processor, computer, node, instance, host, or machine, including those in a networked computing environment.

As used in the present disclosure, a communication channel 20, network 20, cloud 20, or the like, may be or include a collection of devices and/or virtual machines connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A communication channel 20, network 20, cloud 20, or the like, may include, but is not limited to, computing grid systems, peer to peer systems, mesh-type systems, distributed computing environments, cloud computing environment, telephony systems, voice over IP (VoIP) systems, voice communication channels, voice broadcast channels, text-based communication channels, video communication channels, etc. Such communication channels 20, networks 20, clouds 20, or the like, may include hardware and software infrastructures configured to form a virtual organization comprised of multiple resources which may be in geographically disperse locations. Communication channel 20, network 20, cloud 20, or the like, may also refer to a communication medium between processes on the same device. Also as referred to herein, a network element, node, or server may be a device deployed to execute a program operating as a socket listener and may include software instances.

These and other elements of the system 100 will now be further described with reference to the accompanying figures.

### The User Device (e.g., User Device 10) and User Wearable Device (e.g., User Wearable Device 12)

As illustrated in FIG. 1, the system 100 includes one or more user devices (e.g., user device 10). As used in the present disclosure, references to a user 10 may also include a device of the user 10 (or user device 10), and/or vice versa. User devices 10 may include, but are not limited to, mobile phones 10, mobile or personal communication devices 10, tablets 10, wearable devices 12 (e.g., smart watches, smart glasses, smart earphones and headphones, smart speakers, etc.), laptops 10, etc. In an example embodiment, each user device 10 is configurable or configured to provide information to the processor 200. As will be further described in the present disclosure, the processor 200 is configurable or configured to receive information from each user device 10 and generate information sets (e.g., some or all of the pre-journey information sets and/or some or all of the in-journey information sets; as described in the present disclosure). User devices 10 may also be configurable or configured to generate one or more information sets (e.g., one or more pre-journey information sets and/or one or more in-journey information sets; as described in the present disclosure) for the processor 200. Other devices may also be configurable or configured to provide information and/or information sets to the processor 200. Examples of other devices include, but are not limited to, devices fixable or installable in vehicles 14 (e.g., onboard computers, etc.).

### The User Vehicle (e.g., User Vehicle 14)

As illustrated in FIG. 1, the system 100 includes one or more user vehicles (e.g., user vehicle 14 or vehicle 14). Each vehicles 14 may be any transportation vehicle used or to be used by a user 10 for a journey. Vehicles 14 may include, but are not limited to, a car, semi-autonomous vehicle, autonomous vehicle, electric vehicle, solar vehicle, hydrogen-powered vehicle, motorcycle, truck, van, special-purpose vehicle, personal mobility vehicle, other land-based vehicles, boat, other water-based vehicles, train, tram, airplane, other air-based vehicles, etc.

### The Control Center (e.g., Control Center 16)

As illustrated in FIG. 1, the system 100 includes one or more control centers (e.g., control center 16). Each control center 16 may be any physical and/or virtual center for performing a variety of functions, as described in the present disclosure. For example, the control center 16 may include one or more other elements of the system 100, including one or more processors 200 and/or one or more databases 30. Alternatively or in addition, the control center 16 may be in communication, via one or more networks 20, with one or more processors 200, one or more databases 30, one or more user devices 10, one or more user wearable devices 12, one or more vehicles 14, and/or one or more other control centers 16.

In an example embodiment, each control center 16 may include a plurality of graphical displays (not shown) in communication with the one or more processors 200 and/or one or more databases 30. Such graphical displays may be used to display, among other things, information received from user devices 10, user wearable devices 12, vehicles 14, processors 200, databases 30, and/or other control centers 16. For example, the graphical displays may display users 10 (and user devices 10, user wearable devices 12, and vehicles 14) who are about to start on a journey, users 10 (and user devices 10, user wearable devices 12, and vehicles 14) who are currently on a journey, users 10 (and user devices 10, user wearable devices 12, and vehicles 14) who have completed a journey, user operations scores for users 10 (and user devices 10, user wearable devices 12, and vehicles 14), users 10 having user operations scores that exceed a threshold value, rest recommendations for users 10, notifications sent to users 10, etc.

### The Processor (e.g., Processor 200)

As illustrated in at least FIG. 1, the system 100 includes one or more processors (e.g., processor 200). Each processor 200 is configurable or configured to perform a variety of functions, actions, and/or processes, as described in the present disclosure.

For example, each processor 200 is configurable or configured to receive, request, pull, retrieve, and/or obtain information from one or more information sources (including from users 10, user devices 10, wearable devices 12, user vehicles 14, control centers 16, communication channels 20, databases 30, processors 200, authorities (not shown), etc.). Such information may be received in real-time and/or near real-time. Alternatively or in addition, such information may be received in a periodic, intermittent, or sporadic manner (e.g., every 5 seconds, 10 seconds, 15 seconds, 30 seconds, 1 minute, etc.). Alternatively or in addition, such information may be received upon the occurrence (and/or non-occurrence) of an event, action, condition, receipt of certain information, etc. (e.g., movement and/or change of geolocation of the user 10, user device 10, and/or vehicle 14; non-movement or no change of geolocation of the user 10, user device 10, and/or vehicle 14; sudden, unexpected, unplanned, unscheduled, unpredicted, and/or abnormal change in speed, direction, and/or position; deviation from the expected, predicted, scheduled, planned, and/or assigned route for the journey; sudden, unexpected, unplanned, unscheduled, unpredicted, and/or abnormal change in user device 10 usage, activity, and/or movement; sudden, unexpected, unplanned, unscheduled, unpredicted, and/or abnormal change in biometric readings (e.g., when a user 10 is wearing a wearable device 10 that is in communication with the user device 10); sudden, unexpected, unplanned, unscheduled, unpredicted, and/or abnormal change in carbon monoxide or other gas level in the vehicle of the user 10; change in speed pattern, hard accelerations, hard breaking, hard/sharp turns, exceeding of speed limits, change in vehicle directions, etc.). Alternatively or in addition, such information may be or include historic information of the user 10, user device 10, vehicle 14, route for the journey, weather and/or environmental conditions, etc. Alternatively or in addition, such information may be or include benchmark, average, model (or ideal), standard, and/or threshold (predetermined and/or dynamically determined) information.

With such information, the processor 200 is configurable or configured to determine, among other things, how each user 10 has been and/or is currently operating a vehicle 14 (e.g., whether or not the user 10 has been and/or is currently operating the vehicle 14 in a safe, proper, efficient, and/or normal manner). The processor 200 also determines how each user 10 previously operated a vehicle 14 (e.g., whether or not the user 10 previously operated a vehicle 14 in a safe, proper, efficient, and/or normal manner). The processor 200 is also configurable or configured to determine whether or not each user 10 should improve his/her operation of a vehicle 14 to be in a more safe, proper, efficient, and/or normal manner, as well as whether or not each user 10 should take a break from operating a vehicle 14. For more serious situations and/or violations, the processor 200 is configurable or configured to determine whether or not each user 10 should stop operation of a vehicle 14 because the user 10 has been and/or is currently operating the vehicle 14 in an unsafe, improper, inefficient, and/or otherwise abnormal manner. In situations when the processor 200 makes such determination, the processor 200 is configurable or configured to select and perform one or more of a plurality of actions.

In order to achieve the above, the processor 200 assesses whether the user is, will be, and/or was (each as applicable) in a condition to safely, reliably, efficiently, and/or effectively operate the vehicle 14 for the journey. Such assessing includes generating an example embodiment of a user operation score for the user 10 for the journey based on such received information. The user operation score represents vehicular operation risks for the user 10 for the journey as of a particular time (e.g., the first time). The user operation score is generated based on at least pre-journey information, pre-journey information sets, in-journey information, and/or in-journey information sets. For each user operation score, the processor 200 compares the user operation score for the user 10 to a threshold operation score. When the processor 200 determines that the user operation score for the user 10 is less than or equal to a threshold operation score, the processor 200 performs one or more of the following: sends a notification to the user to stop vehicular operations; sends a notification to the user to rest; sends a notification to an authority (e.g., control center, command center, supervisor, headquarter, police or other law enforcement, traffic authorities, etc.) regarding potentially unsafe vehicular operations by the user of the vehicle; sends a command to remotely control (e.g., speed, direction, etc. of the vehicle; audio device of the vehicle; roll down one or more windows of the vehicle; etc.), automatically control (e.g., autonomous vehicle mode or semi-autonomous vehicle mode), limit the control of, and/or shut down the vehicle that is being operated by the user; and/or sends a command to remotely control, automatically control, limit the control of, and/or shut down the mobile device 10 of the user 10.

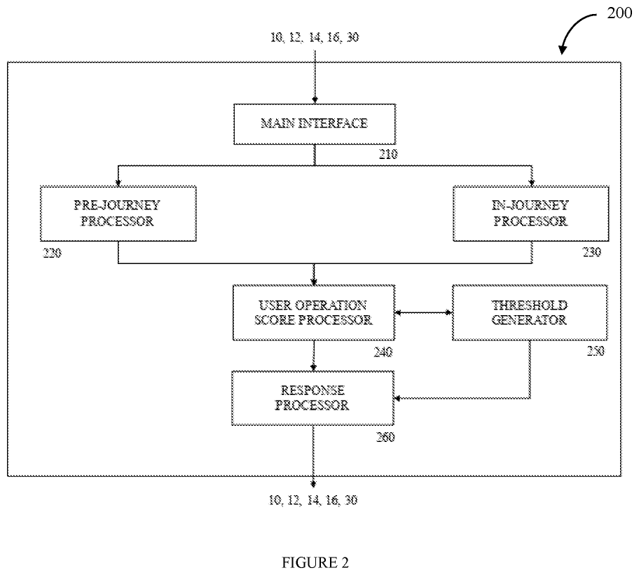

To perform the processes, methods, and/or actions described above and in the present disclosure, example embodiments of the processor 200 include one or more elements. For example, as illustrated in at least FIG. 2, the processor 200 may include one or more main interfaces 210 for receiving, requesting, obtaining, selecting, filtering, and/or routing information received from the information sources. The processor 200 may also include one or more pre-journey processors 220 for processing pre-journey-related information. The processor 200 may also include one or more in-journey processors 230 for processing in-journey-related information. The processor 200 may also include one or more user operation score processors 240 for generating one or more user operation scores (e.g., a user operation score for a first user 10, for a first journey, on a first date/time, and with a first start time). The processor 200 may also include one or more threshold generators 250 for selecting predetermined threshold operation scores and/or dynamically generating threshold operation scores. The processor 200 may also include one or response processors 260 for generating responses based on user operation scores generated by the user operation score processor 240. For example, a response generated by the response processor 260 may be a notification to the user 10 (e.g., a response indicating the user 10 can proceed to operate the vehicle; a response indicating the user 10 should take certain rests or breaks during the journey; a response indicating the user 10 should not operate the vehicle; etc.). The response generated by the response processor 260 may also be a notification to one or more control centers 16. The response generated by the response processor 260 may also be a notification to one or more authorities (e.g., control center 16, supervisor of the user, police, etc.). The response generated by the response processor 260 may also be a direct command to the vehicle 14 to shut down, deactivate, remotely control, switch to auto-pilot, and/or otherwise prevent one or more functionalities or user 10 controls of the vehicle 14. The response generated by the response processor 260 may also be a direct command to the user device 10 to shut down, deactivate, remotely control, and/or otherwise prevent one or more functionalities of the user device 10.

Although the figures may illustrate one main interface 210, one pre-journey processor 220, one in-journey processor 230, one user operation score processor 240, one threshold generator 250, and one response processor 260, it is to be understood that the processor 200 may include more or less than one main interface 210, more or less than one pre-journey processor 220, more or less than one in-journey processor 230, more or less than one user operation score processor 240, more or less than one threshold generator 250, and/or more or less than one response processor 260 without departing from the teachings of the present disclosure. It is also to be understood in the present disclosure that, although the functions and/or processes performed by the processor 200 are described in the present disclosure as being performed by particular elements of the processor 200, the functions and/or processes performed by a particular element of the processor 200 may also be performed by one or more other elements and/or cooperatively performed by more than one element of the processor 200 without departing from the teachings of the present disclosure. It is also to be understood in the present disclosure that, although the functions and/or processes performed by the processor 200 are described in the present disclosure as being performed by particular elements of the processor 200, the functions and/or processes performed by two or more particular elements of the processor 200 may be combined and performed by one element of the processor 200 without departing from the teachings of the present disclosure.

These elements of the processor 200 will now be further described with reference to the accompanying figures.

### The Main Interface (e.g., Main Interface 210)

As illustrated in FIG. 2, the processor 200 includes one or more main interfaces (e.g., main interface 210). Each main interface 210 is configurable or configured to receive, request, pull, retrieve, and/or obtain information from one or more information sources. Information sources include, but are not limited to, users 10, user devices 10, wearable devices 12, user vehicles 14 (and/or onboard communication devices of vehicles 14), control centers 16, networks 20 or communication channels 20, databases 30, other elements of the processor 200, other processors 200, authorities (not shown), etc.

For example, in respect to pre-journey information and/or pre-journey information sets, the main interface 210 receives information pertaining to a start time for a journey from a user 10, user device 10, vehicle 14, wearable device 12, control center 16, database 30, network 20 or communication channel 20, one or more other elements of the processor 200, other processors 200, and/or other information sources. The main interface 210 also receives information pertaining to estimated distance(s) for the journey, route information for the journey, etc., as estimated before the start of the journey (e.g., pre-journey geolocation information or pre-journey geolocation information set, as further described in the present disclosure), which may be received from the user 10, user device 10 (e.g., via a map application, such as Google Maps, Apple Maps, etc.), vehicle 14, wearable device 12, control center 16, database 30, network 20 or communication channel 20, one or more other elements of the processor 200, other processors 200, and/or other information sources. The main interface 210 also receives information pertaining to estimated total travel time for the journey, as estimated before the start of the journey (e.g., pre-journey duration information or pre-journey duration information set, as further described in the present disclosure), which may be received from the user 10, user device (e.g., via a map application, such as Google Maps, Apple Maps, etc.), vehicle 14, wearable device 12, control center 16, database 30, network 20 or communication channel 20, one or more other elements of the processor 200, other processors 200, and/or other information sources. The main interface 210 also receives information pertaining to usage of the user device 10 before the user 10 starts operating the vehicle 14 for the journey, such as duration of usage, types of apps used, user interactions with the mobile device, network activity, amount of data transmitted/received, etc. (e.g., pre-journey device activity information or pre-journey device activity information set, as further described in the present disclosure), which may be received from the user 10, user device 10, wearable device 12, control center 16, telecommunications provider, database 30, network 20 or communication channel 20, one or more other elements of the processor 200, other processors 200, and/or other information sources. The main interface 210 also receives information pertaining to the user's biometric information/readings before the user 10 starts to operate the vehicle 14 for the journey (e.g., pre-journey biometric information or pre-journey biometric information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to a hazardous gas level (and/or hazardous level of gas) within the vehicle 14 before the user 10 starts operating the vehicle 14 for the journey (e.g., pre-journey hazardous gas information or pre-journey hazardous gas information set, as further described in the present disclosure), which may be received from the user 10, user device 10, wearable device 12, control center 16, vehicle 14, database 30, network 20 or communication channel 20, one or more other elements of the processor 200, other processors 200, and/or other information sources. The main interface 210 also receives information pertaining to historic information (e.g., the user's history, experience, and/or performance with operating a vehicle: for similar or same journey; at a time of the day corresponding to the start time; on a day of the week corresponding to the day of the journey; on a day of the month corresponding to the day of the journey; after similar or same mobile device usage before starting operation of a vehicle; with similar or same biometric information/readings before starting operation of a vehicle), which may be received from the user 10, user device 10, wearable device 12, control center 16, database 30, network 20 or communication channel 20, one or more other elements of the processor 200, other processors 200, and/or other information sources. The main interface 210 may also receive information pertaining to benchmarks, averages, model (or ideal), standard, and/or threshold (predetermined and/or dynamically determined) information, which may be used by one or more elements of the processor 200 to process, compare, reference, etc. with one or more pre-journey information and/or pre-journey information sets described above and in the present disclosure.

In respect to in journey information and/or in-journey information sets, the main interface 210 receives information pertaining to an amount of time between the start time and a first time (which is a time during the journey between the start time and end time), estimated remaining time for the journey as of the first time, estimated duration for the journey (including an estimated total travel time for the journey), etc., as estimated as of the first time (e.g., in-journey duration information or in-journey duration information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to any particular time (e.g., the first time, which may be a time of the day, a day of the week, a day of the month, etc.) when example embodiments of the processor 200 (and/or one or more elements of the processor 200) perform an action (e.g., in temporal information or in temporal information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to present location information as of the first time (including geolocation information of the user device as of the first time), estimated distance for the journey estimated as of the first time (including an estimated total distance for the journey as of the first time), route information for the journey as of the first time, etc. (e.g., in-journey geolocation information or in-journey geolocation information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to usage of the user device 10 by the user 10 between the start time and the first time (e.g., in-journey device activity information or in-journey device activity information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to real-time biometric information of the user 10 as of the first time, biometric information of the user 10 obtained between the start time and the first time, etc. (e.g., in-journey biometric information or in-journey biometric information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to real-time weather conditions, real-time traffic conditions, weather conditions between the start time and the first time, traffic conditions between the start time and the first time, weather condition forecasts for the rest of the first journey, traffic condition forecasts for the rest of the first journey, etc. (e.g., in-journey environmental information or in-journey environmental information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives information pertaining to rest times, frequencies, and/or recommendations during the journey, as estimated as of the first time, based on information described above and in the present disclosure (e.g., in-journey rest information or in-journey rest information set, as further described in the present disclosure), which may be received from the user 10, user device 10, wearable device 12, control center 16, database 30, network 20 or communication channel 20, one or more other elements of the processor 200, other processors 200, and/or other information sources. The main interface 210 also receives real-time information pertaining to a hazardous gas level (or hazardous level of gas) within the vehicle 14 obtained between the start time and the first time (e.g., in-journey hazardous gas information or in-journey hazardous gas information set, as further described in the present disclosure), which may be received from the user 10, user device 10, wearable device 12, vehicle 14, control center 16, database 30, network or communication channel 20, one or more other elements of the processor 200, other processors 200, and/or other information sources. The main interface 210 also receives real-time information pertaining to fuel consumption of the vehicle 14 obtained between the start time and the first time (e.g., in-journey fuel consumption information or in-journey fuel consumption information set, as further described in the present disclosure), which may be received from the user 10, user device 10, wearable device 12, vehicle 14, control center 16, database 30, network 20 or communication channel 20, one or more other elements of the processor 200, other processors 200, and/or other information sources. The main interface 210 may also receive information pertaining to benchmarks, averages, model (or ideal), standard, and/or threshold (predetermined and/or dynamically determined) information, which may be used by one or more elements of the processor 200 to process, compare, reference, etc. with one or more in-journey information and/or in-journey information sets described above and in the present disclosure.

The information received by the main interface 210, as described above and in the present disclosure, may be received in real-time and/or near real-time. Alternatively or in addition, such information may be received in a periodic, intermittent, or sporadic manner (e.g., every 5 seconds, 10 seconds, 15 seconds, 30 seconds, 1 minute; no fixed period or pattern; etc.). Alternatively or in addition, such information may be received upon the occurrence (and/or non-occurrence) of an event, sequence of events, action, sequence of actions, condition, sequence of conditions, receipt of certain information, receipt of a sequence of certain information, process, sequence of processes, etc. (e.g., movement and/or change of geolocation of the user 10, user device 10, and/or vehicle 14; non-movement or no change of geolocation of the user 10, user device 10, and/or vehicle 14; sudden, unexpected, unplanned, unscheduled, unpredicted, and/or abnormal change in speed, direction, and/or position; deviation from the expected, predicted, scheduled, planned, and/or assigned route for the journey; sudden, unexpected, unplanned, unscheduled, unpredicted, and/or abnormal change in user device 10 usage, activity, and/or movement; sudden, unexpected, unplanned, unscheduled, unpredicted, and/or abnormal change in biometric readings (e.g., when a user 10 is wearing a wearable device 10 that is in communication with the user device 10); sudden, unexpected, unplanned, unscheduled, unpredicted, and/or abnormal change in carbon monoxide or other gas level in the vehicle of the user 10; sudden, unexpected, unplanned, unscheduled, unpredicted, and/or abnormal stop or rest; missing or skipping of a scheduled or recommended stop or rest; change in speed pattern, hard accelerations, hard breaking, hard/sharp turns, exceeding of speed limits, change in vehicle directions, etc.). Alternatively or in addition, such information may be or include historic information of the user 10, user device 10, vehicle 14, route for the journey, weather and/or environmental conditions, etc. Alternatively or in addition, such information may be or include benchmark, average, model (or ideal), standard, and/or threshold (predetermined and/or dynamically determined) information.

### The Pre-Journey Processor (e.g., Pre-Journey Processor 220)

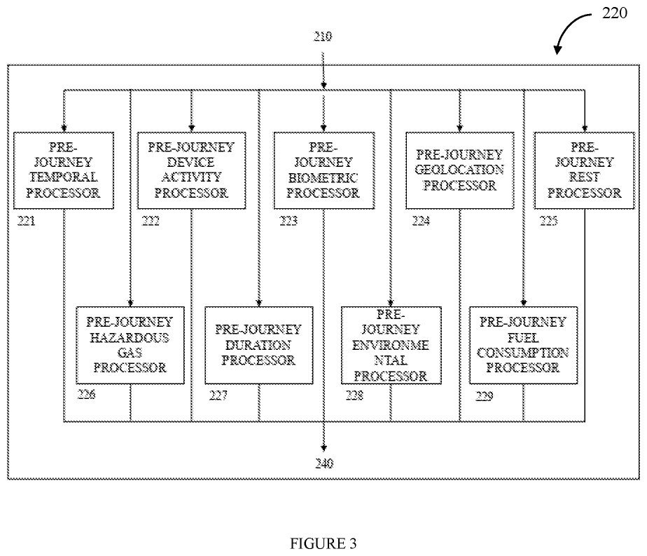

As illustrated in FIG. 2 and FIG. 3, the processor 200 includes one or more pre-journey processors (e.g., pre-journey processor 220). Each pre-journey processor 220 is configurable or configured to receive, among other things, pre-journey information and/or pre-journey information sets from the main interface 210 (and/or directly from one or more information sources). The pre-journey processor 220 is then configurable or configured to process such information, and provide such processed information to one or more other elements of the processor 200.

The processing by each pre-journey processor 220 may include, but is not limited to, performing a selection of information from among the information received, generating information sets (or information payloads, which may also include scores and/or recommendations), selectively ordering the information sets based on one or more criterion, and providing and/or making available selected/generated information sets to one or more other elements of the processor 200. For example, as further described below and in the present disclosure, the pre-journey processor 220 generates a plurality of different information sets, scores, and/or recommendations (e.g., pre-journey temporal score, pre-journey device activity score, pre-journey biometric score, pre-journey geolocation score, pre-journey rest score and/or recommendation, pre-journey hazardous gas score, pre-journey duration score, pre-journey environmental score, and/or pre-journey fuel consumption score) for the user operation score processor 240 to use in generating one or more user operation scores.

To perform the processes, methods, and/or actions described above and in the present disclosure, example embodiments of the pre-journey processor 220 include one or more elements. For example, as illustrated in at least FIG. 3, the pre-journey processor 220 may include one or more pre-journey temporal processors 221 for processing information pertaining to the first time and the end time (e.g., in the form of time of the day, day of the week, and/or day of the month; based on pre-journey information). The pre-journey processor 220 may also include one or more pre-journey device activity processors 222 for processing information pertaining to user device 10 usage by the user 10 during a particular time period immediately preceding the start time. The pre-journey processor 220 may also include one or more pre-journey biometric processors 223 for processing information pertaining to biometric information of the user 10 obtained immediately before the start time and/or during a particular time period immediately preceding the start time. The pre-journey processor 220 may also include one or more pre-journey geolocation processors 224 for processing information pertaining to estimated distance for the journey and/or estimated route information for the journey, as estimated before the start time (or based on pre-journey information). The pre-journey processor 220 may also include one or more pre-journey rest processors 225 for processing information pertaining to rest recommendations for the user 10 based on pre-journey information. The pre-journey processor 220 may also include one or more pre-journey hazardous gas processors 226 for processing information pertaining to a hazardous gas level (and/or hazardous level of gas) within the vehicle 14 of the user 10 obtained during a particular time period immediately preceding the start time (or based on pre-journey information). The pre-journey processor 220 may also include one or more pre-journey duration processors 227 for processing information pertaining to estimated total travel time for the journey, as estimated before the start time (or based on pre-journey information). The pre-journey processor 220 may also include one or more pre-journey environmental processors 228 for processing information pertaining to weather conditions, traffic conditions, etc., as estimated before the start time (or based on pre-journey information). The pre-journey processor 220 may also include one or more pre-journey fuel consumption processors 229 for processing information pertaining to fuel consumption of the vehicle 14 of the user 10, as estimated before the start time (or based on pre-journey information).

Although the figures may illustrate one pre-journey temporal processors 221, one pre-journey device activity processors 222, one pre-journey biometric processors 223, one pre-journey geolocation processors 224, one pre-journey rest processors 225, one pre-journey hazardous gas processors 226, one pre-journey duration processors 227, one pre-journey environmental processors 228, and one pre-journey fuel consumption processors 229, it is to be understood that the pre-journey processor 220 may include more or less than one pre-journey temporal processors 221, more or less than one pre-journey device activity processors 222, more or less than one pre-journey biometric processors 223, more or less than one pre-journey geolocation processors 224, more or less than one pre-journey rest processors 225, more or less than one pre-journey hazardous gas processors 226, more or less than one pre-journey duration processors 227, more or less than one pre-journey environmental processors 228, and more or less than one pre-journey fuel consumption processors 229 without departing from the teachings of the present disclosure. It is also to be understood in the present disclosure that, although the functions and/or processes performed by the pre-journey processor 220 are described in the present disclosure as being performed by particular elements of the pre-journey processor 220, the functions and/or processes performed by a particular element of the pre-journey processor 220 may also be performed by one or more other elements and/or cooperatively performed by more than one element of the processor 200 without departing from the teachings of the present disclosure. It is also to be understood in the present disclosure that, although the functions and/or processes performed by the pre-journey processor 220 are described in the present disclosure as being performed by particular elements of the pre-journey processor 220, the functions and/or processes performed by two or more particular elements of the pre-journey processor 220 may be combined and performed by one element of the processor 200 without departing from the teachings of the present disclosure.

These elements of the pre-journey processor 220 will now be further described with reference to the accompanying figures.

### The Pre-Journey Temporal Processor (e.g., Pre-Journey Temporal Processor 221)

As illustrated in FIG. 3, the pre-journey processor 220 includes one or more pre-journey temporal processors (e.g., pre-journey temporal processor 221). Each pre-journey temporal processor 221 is configurable or configured to process information pertaining to an estimated or expected start time and/or estimated or expected end time for the journey (which may be in the form of a time of the day, day of the week, and/or day of the month), as provided by the main interface 210, one or more elements of the processor 200, and/or one or more information sources. In some example embodiments, the pre-journey temporal processor 221 generates estimated or expected start times for the journey and/or estimated or expected end times for the journey.

In processing such information, the pre-journey temporal processor 221 is configurable or configured to assess, analyze, and/or predict, among other things, a likelihood that the user can safely, reliably, efficiently, and/or effectively operate the vehicle 14 at such (or similar) start time, throughout the journey (based on such (or similar) start time), and/or up to such (or similar) end time. The pre-journey temporal processor 221 may perform such assessment, analysis, and/or prediction based on historic information, average information, acceptable/threshold information, benchmark information, etc. For example, the pre-journey temporal processor 221 may search for and/or obtain historic information pertaining to prior user operation scores, prior pre-journey temporal scores, and/or prior experience of the user 10 operating any vehicle 14 at such (or similar) start time, throughout the journey (based on such (or similar) start time), and/or up to such (or similar) end time. Alternatively or in addition, the pre-journey temporal processor 221 may search for and/or obtain historic information pertaining to prior user operation scores, prior pre-journey temporal scores, and/or prior experience of the user 10 operating this particular vehicle 14 at such (or similar) start time, throughout the journey (based on such (or similar) start time), and/or up to such (or similar) end time. Alternatively or in addition, the pre-journey temporal processor 221 may search for and/or obtain historic information pertaining to prior user operation scores, prior pre-journey temporal scores, and/or prior experience of the user 10 for this particular journey and/or similar/comparable journeys at such (or similar) start time, throughout the journey (based on such (or similar) start time), and/or up to such (or similar) end time.

The pre-journey temporal processor 221 is then configurable or configured to assess, analyze, and/or predict, among other things, a likelihood that the user 10 can safely, reliably, efficiently, and/or effectively operate the vehicle 14 at such start time, throughout the journey (based on such start time), and/or up to such end time based on such searched for and/or obtained historic information. More specifically, the pre-journey temporal processor 221 is configurable or configured to generate a score, or the like, such as a pre-journey temporal score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) at such start time, throughout the journey (based on such start time), and/or up to such end time.

As a non-limiting illustrative example, the pre-journey temporal processor 221 may receive an estimated start time of a first journey for a first user 10 operating a first vehicle 14 to be 3 am on Monday 7 Jun. 2021. Based on the first journey, the pre-journey temporal processor 221 may estimate an end time to be Bpm on Monday 7 Jun. 2021. In searching for historic information, the pre-journey temporal processor 221 may determine that the first user 10 has little or no history/experience for journeys having a start time of 3 am (e.g., typical start times for the first user 10 on Mondays is 10 am), an end time of Bpm (e.g., typical end times for the first user 10 on Mondays is 1 pm), a journey duration of 17 hours (e.g., typical journey durations for the first user 10 on Mondays is 3 hours). In such an example, the pre-journey temporal processor 221 may determine that the first user 10 has a low likelihood of safely, reliably, efficiently, and/or effectively operating the first vehicle 14 for the first journey based on the estimated start time, estimated end time, and date of the journey. Accordingly, the pre-journey temporal processor 221 may generate a low pre-journey temporal score for the first user 10 operating the first vehicle 14 for the first journey based on the estimated start time, estimated end time, and date of the journey.

As another non-limiting illustrative example, the pre-journey temporal processor 221 may identify (or receive) an estimated start time of a second journey for a second user 10 operating a second vehicle 14 to be 7 am on Wednesday 9 Jun. 2021. Based on the second journey, the pre-journey temporal processor 221 may estimate an end time to be 5 pm on Wednesday 9 Jun. 2021. In searching for historic information, the pre-journey temporal processor 221 may determine that the second user 10 has significant or extensive history/experience for journeys having a start time of around 7 am (e.g., typical start times for the second user 10 on Wednesdays is 8 am), an end time of 5 pm (e.g., typical end times for the second user 10 on Wednesdays is 6 pm), a journey duration of 10 hours (e.g., typical journey durations for the first user 10 on Wednesdays is 11 hours). In such an example, the pre-journey temporal processor 221 may determine that the second user 10 has a high likelihood of safely, reliably, efficiently, and/or effectively operating the second vehicle 14 for the second journey based on the estimated start time (as estimated before the start time), estimated end time (as estimated before the start time), and date of the second journey. Accordingly, the pre-journey temporal processor 221 may generate a high pre-journey temporal score for the second user 10 operating the second vehicle 14 for the second journey based on the estimated start time (as estimated before the start time), estimated end time (as estimated before the start time), and date of the second journey.

### The Pre-Journey Device Activity Processor (e.g., Pre-Tourney Device Activity Processor 222)

As illustrated in FIG. 3, the pre-journey processor 220 includes one or more pre-journey device activity processors (e.g., pre-journey device activity processor 222). Each pre-journey device activity processor 222 is configurable or configured to process information pertaining to pre-journey user device 10 usage (i.e., usage of the user device 10 leading up to and/or before the start of the journey (or before the start time)), as provided by the main interface 210, one or more elements of the processor 200, and/or one or more information sources. As used in the present disclosure, user device usage (or user device 10 usage) information includes, but is not limited to, information pertaining to duration of usage of the user device 10, types of apps used on the user device 10, user interactions with the user device 10 (e.g., touches on touchscreen, pressing of buttons, speaking into microphone, speaking to digital assistant, use of camera, etc.), network activity of the user device 10, amount of data transmitted by the user device 10, amount of data received by the user device 10, changes in orientation (and/or movements measurable by an accelerometer, or the like, of the user device 10), etc.

In processing such information, the pre-journey device activity processor 222 is configurable or configured to assess, analyze, and/or predict, among other things, a likelihood that the user 10 can safely, reliably, efficiently, and/or effectively operate the vehicle 14 based on such (or similar) pre-journey user device 10 usage. The pre-journey device activity processor 222 may also perform such assessment, analysis, and/or prediction based on historic information, average information, acceptable/threshold information, benchmark information, etc. For example, the pre-journey device activity processor 222 may search for and/or obtain historic information pertaining to prior user operation scores, prior pre-journey device activity scores, and/or prior experience of the user 10 operating any vehicle 14 based on such (or similar) pre-journey user device 10 usage. Alternatively or in addition, the pre-journey device activity processor 222 may search for and/or obtain historic information pertaining to prior user operation scores, prior pre-journey device activity scores, and/or prior experience of the user 10 operating this particular vehicle 14 based on such (or similar) pre-journey user device 10 usage. Alternatively or in addition, the pre-journey device activity processor 222 may search for and/or obtain historic information pertaining to prior user operation scores, prior pre-journey device activity scores, and/or prior experience of the user 10 for this particular journey and/or similar/comparable journeys based on such (or similar) pre-journey user device 10 usage.

The pre-journey device activity processor 222 is then configurable or configured to assess, analyze, and/or predict, among other things, a likelihood that the user 10 can safely, reliably, efficiently, and/or effectively operate the vehicle 14 based on the pre-journey user device 10 usage information and/or such searched for and/or obtained historic information. More specifically, the pre-journey device activity processor 222 is configurable or configured to generate a score, or the like, such as a pre-journey device activity score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey user device 10 usage.

As a non-limiting illustrative example, the pre-journey device activity processor 222 may receive pre-journey device usage information (or device activity information) for a first journey for a first user 10 operating a first vehicle 14. The pre-journey device usage information may indicate extensive use of certain applications of the user device 10 before and/or leading up to the estimated or expected start time (e.g., 2 hours of continuously watching Netflix, Disney+, Tiktok, YouTube, etc.; and/or 1 hour of continuously playing Fortnite; and/or 1 hour of continuously trading stocks and/or cryptocurrencies; etc.). In searching for historic information, the pre-journey device activity processor 222 may determine that the first user 10 has little or no history/experience for journeys in which the first user 10 has such extensive pre-journey device usage. In such an example, the pre-journey device activity processor 222 may determine that the first user 10 has a low likelihood of safely, reliably, efficiently, and/or effectively operating the first vehicle 14 for the first journey based on such extensive pre-journey device usage. Accordingly, the pre-journey device activity processor 222 may generate a low pre-journey device activity score for the first user 10 operating the first vehicle 14 for the first journey based on such extensive pre-journey device usage.

As another non-limiting illustrative example, the pre-journey device activity processor 222 may receive pre-journey device usage information (or device activity information) for a second journey for a second user 10 operating a second vehicle 14. The pre-journey device usage information may indicate little use of the user device 10 before and/or leading up to the estimated or expected start time (e.g., checking of emails for a few minutes; browsing the internet for a few minutes; etc.). In such a situation, the pre-journey device activity processor 222 may not be required to perform searches of historic information (since such conditions are safe for any user 10). Alternatively, if the pre-journey device activity processor 222 performs searches for historic information, the pre-journey device activity processor 222 may determine that the second user 10 has similar history/experience for journeys in which the second user 10 has little (or more) pre-journey device usage. In such an example, the pre-journey device activity processor 222 may determine that the second user 10 has a high likelihood of safely, reliably, efficiently, and/or effectively operating the second vehicle 14 for the second journey based on such little pre-journey device usage. Accordingly, the pre-journey device activity processor 222 may generate a high pre-journey device activity score for the second user 10 operating the second vehicle 14 for the second journey based on such little pre-journey device usage.

### The Pre-Journey Biometric Processor (e.g., Pre-Journey Biometric Processor 223)

As illustrated in FIG. 3, the pre-journey processor 220 includes one or more pre-journey biometric processors (e.g., pre-journey biometric processor 223). Each pre-journey biometric processor 223 is configurable or configured to process information pertaining to pre-journey biometric information (i.e., biometric readings of the user 10 obtained for the user 10 before the start of the journey (or before the start time)), as provided by the main interface 210, one or more elements of the processor 200, and/or one or more information sources. As used in the present disclosure, biometric information (or readings) includes, but is not limited to, information pertaining to heart rate, blood pressure, ECG, retina scans, facial scans, oxygen saturation level, blood oxygen saturation level (SpO2).

In processing such information, the pre-journey biometric processor 223 is configurable or configured to assess, analyze, and/or predict, among other things, a likelihood that the user can safely, reliably, efficiently, and/or effectively operate the vehicle 14 based on such (or similar) pre-journey biometric information. The pre-journey biometric processor 223 may also perform such assessment, analysis, and/or prediction based on historic information, average information, acceptable/threshold information, benchmark information, etc. For example, the pre-journey biometric processor 223 may search for and/or obtain historic information pertaining to prior user operation scores, prior pre-journey biometric scores, and/or prior experience of the user 10 operating any vehicle 14 based on such (or similar) pre-journey biometric information. Alternatively or in addition, the pre-journey biometric processor 223 may search for and/or obtain historic information pertaining to prior user operation scores, prior pre-journey biometric scores, and/or prior experience of the user 10 operating this particular vehicle 14 based on such (or similar) pre-journey biometric information. Alternatively or in addition, the pre-journey biometric processor 223 may search for and/or obtain historic information pertaining to prior user operation scores, prior pre-journey biometric scores, and/or prior experience of the user 10 for this particular journey and/or similar/comparable journeys based on such (or similar) pre-journey biometric information.

The pre-journey biometric processor 223 is then configurable or configured to assess, analyze, and/or predict, among other things, a likelihood that the user 10 can safely, reliably, efficiently, and/or effectively operate the vehicle 14 based on the pre-journey biometric information and/or such searched for and/or obtained historic information. More specifically, the pre-journey biometric processor 223 is configurable or configured to generate a score, or the like, such as a pre-journey biometric score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey biometric information.

As a non-limiting illustrative example, the pre-journey biometric processor 223 may receive pre-journey biometric information (i.e., biometric readings) for a first journey for a first user 10 operating a first vehicle 14. The pre-journey biometric information may indicate abnormal biometric readings for the first user 10 before and/or leading up to the estimated or expected start time (e.g., mismatch in facial features, etc.). In searching for historic information, the pre-journey biometric processor 223 may determine that the first user 10 has little or no history/experience for journeys in which the first user 10 has such abnormal biometric readings. In such an example, the pre-journey biometric processor 223 may determine that the first user has a low likelihood of safely, reliably, efficiently, and/or effectively operating the first vehicle 14 for the first journey based on such abnormal biometric readings. Accordingly, the pre-journey biometric processor 223 may generate a low pre-journey biometric score for the first user 10 operating the first vehicle 14 for the first journey based on such abnormal biometric readings.

As another non-limiting illustrative example, the pre-journey biometric processor 223 may receive pre-journey biometric information (i.e., biometric readings) for a second journey for a second user 10 operating a second vehicle 14. The pre-journey biometric information may indicate normal biometric readings before and/or leading up to the estimated or expected start time. In such a situation, the pre-journey biometric processor 223 may not be required to perform searches of historic information (since such conditions are safe for any user 10). Alternatively, if the pre-journey biometric processor 223 performs searches for historic information, the pre-journey biometric processor 223 may determine that the second user 10 has similar history/experience for journeys in which the second user 10 has normal biometric readings. In such an example, the pre-journey biometric processor 223 may determine that the second user 10 has a high likelihood of safely, reliably, efficiently, and/or effectively operating the second vehicle 14 for the second journey based on such normal biometric readings. Accordingly, the pre-journey biometric processor 223 may generate a high pre-journey biometric score for the second user 10 operating the second vehicle 14 for the second journey based on such normal biometric readings.

### The Pre-Journey Geolocation Processor (e.g., Pre-Journey Geolocation Processor 224)

As illustrated in FIG. 3, the pre-journey processor 220 includes one or more pre-journey geolocation processors (e.g., pre-journey geolocation processor 224). Each pre-journey geolocation processor 224 is configurable or configured to process information pertaining to pre-journey geolocation information (i.e., geolocation information for the journey, as estimated or derived before the start of the journey (or before the start time)), as provided by the main interface 210, one or more elements of the processor 200, and/or one or more information sources. As used in the present disclosure, geolocation information includes, but is not limited to, information pertaining to current location, estimated distance for a journey, estimated routes (or route information) for a journey, etc.

In processing such information, the pre-journey geolocation processor 224 is configurable or configured to assess, analyze, and/or predict, among other things, a likelihood that the user 10 can safely, reliably, efficiently, and/or effectively operate the vehicle 14 based on such (or similar) pre-journey geolocation information. The pre-journey geolocation processor 224 may also perform such assessment, analysis, and/or prediction based on historic information, average information, acceptable/threshold information, benchmark information, etc. For example, the pre-journey geolocation processor 224 may search for and/or obtain historic information pertaining to prior user operation scores, prior pre-journey geolocation scores, and/or prior experience of the user 10 operating any vehicle 14 based on such (or similar) pre-journey geolocation information. Alternatively or in addition, the pre-journey geolocation processor 224 may search for and/or obtain historic information pertaining to prior user operation scores, prior pre-journey geolocation scores, and/or prior experience of the user 10 operating this particular vehicle 14 based on such (or similar) pre-journey geolocation information. Alternatively or in addition, the pre-journey geolocation processor 224 may search for and/or obtain historic information pertaining to prior user operation scores, prior pre-journey geolocation scores, and/or prior experience of the user 10 for this particular journey and/or similar/comparable journeys based on such (or similar) pre-journey geolocation information.

The pre-journey geolocation processor 224 is then configurable or configured to assess, analyze, and/or predict, among other things, a likelihood that the user 10 can safely, reliably, efficiently, and/or effectively operate the vehicle 14 based on the pre-journey geolocation information and/or such searched for and/or obtained historic information. More specifically, the pre-journey geolocation processor 224 is configurable or configured to generate a score, or the like, such as a pre-journey geolocation score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey geolocation information.

As a non-limiting illustrative example, the pre-journey geolocation processor 224 may receive pre-journey geolocation information of a first journey for a first user 10 operating a first vehicle 14, including an estimated total distance for the first journey of 800 km and an estimated route between geolocation A and geolocation B. In searching for historic information, the pre-journey geolocation processor 224 may determine that the first user 10 has little or no history/experience for journeys having an estimated total distance of 800 km (e.g., typical total distances for the first user 10 is 80 km); and little or no history/experience travelling the route between geolocation A and geolocation B. In such an example, the pre-journey geolocation processor 224 may determine that the first user 10 has a low likelihood of safely, reliably, efficiently, and/or effectively operating the first vehicle 14 for the first journey based on the pre-journey geolocation information. Accordingly, the pre-journey geolocation processor 224 may generate a low pre-journey geolocation score for the first user 10 operating the first vehicle 14 for the first journey based on the pre-journey geolocation information.

As another non-limiting illustrative example, the pre-journey geolocation processor 224 may receive pre-journey geolocation information of a second journey for a second user 10 operating a second vehicle 14, including a total distance for the second journey of 30 km and an estimated route between geolocation C and geolocation D. In searching for historic information, the pre-journey geolocation processor 224 may determine that the second user 10 has significant or extensive history/experience for journeys having an estimated total distance of 30 km (e.g., typical total distances for the second user 10 is 50 km); and significant or extensive history/experience travelling the route between geolocation C and geolocation D (e.g., this is the regular route for the second user 10). In such an example, the pre-journey geolocation processor 224 may determine that the second user 10 has a high likelihood of safely, reliably, efficiently, and/or effectively operating the second vehicle 14 for the second journey based on the pre-journey geolocation information. Accordingly, the pre-journey geolocation processor 224 may generate a high pre-journey geolocation score for the second user 10 operating the second vehicle 14 for the second journey based on the pre-journey geolocation information.

### The Pre-Journey Rest Processor (e.g., Pre-Journey Rest Processor 225)

As illustrated in FIG. 3, the pre-journey processor 220 includes one or more pre-journey rest processors (e.g., pre-journey rest processor 225). Each pre-journey rest processor 225 is configurable or configured to generate one or more pre-journey recommendations on rest stops/breaks for the user 10 during a journey (including when to rest, duration of each rest, quantity of rest stops/breaks, where/geolocation to rest, etc.) so as to ensure the user 10 can safely, reliably, efficiently, and/or effectively operate the vehicle 14 for the journey. The pre-journey rest processor 225 may generate such recommendations based on a plurality of information.

For example, the rest recommendations may be generated based on pre-journey information, such as a start time for the journey (or pre-journey start time, as estimated prior to the start time by the pre-journey temporal processor 221), end time for the journey (or pre-journey end time, as estimated prior to the start time by the pre-journey temporal processor 221), pre-journey user device 10 usage (i.e., usage of the user device 10 before the start of the journey (or before the start time), as processed by the pre-journey device activity processor 222), pre-journey biometric information (i.e., biometric readings of the user 10 obtained for the user 10 before the start of the journey (or before the start time), as processed by the pre-journey biometric processor 223), pre-journey geolocation information (i.e., geolocation information for the journey, as estimated, derived, and/or predicted before the start of the journey (or before the start time) by the pre-journey geolocation processor 224), pre-journey duration information (i.e., duration information or total travel time for the journey, as estimated, derived, or predicted before the start of the journey (or before the start time) by pre-journey duration processor 227), pre-journey environmental information (i.e., environmental information for the journey, as estimated, derived, or predicted before the start of the journey (or before the start time) by the pre-journey environmental processor 228), pre-journey fuel consumption information (i.e., fuel consumption information for the journey, as estimated, derived, or predicted before the start of the journey (or before the start time) by the pre-journey fuel consumption processor 229), and/or pre-journey hazardous gas information (i.e., hazardous gas information for the vehicle 14 for the journey, as estimated, derived, or predicted before the start of the journey (or before the start time) by the pre-journey hazardous gas processor 226). Such information may be received from the main interface 210, one or more elements of the processor 200, and/or one or more information sources.

Alternatively or in addition, the rest recommendations may be generated based on one or more pre-journey scores for the user 10 for the journey, such as the pre-journey temporal score generated by the pre-journey temporal processor 221, the pre-journey device activity score generated by the pre-journey device activity processor 222, the pre-journey biometric score generated by the pre-journey biometric processor 223, the pre-journey geolocation score generated by the pre-journey geolocation processor 224, the pre-journey rest score generated by the pre-journey rest processor 225, the pre-journey hazardous gas score generated by the pre-journey hazardous gas processor 226, the pre-journey duration score generated by the pre-journey duration processor 227, the pre-journey environmental score generated by the pre-journey environmental processor 228, and/or the pre-journey fuel consumption score generated by the pre-journey fuel consumption processor 229.

Alternatively or in addition, the rest recommendations may be generated based on historic information, average information, acceptable/threshold information, benchmark information, etc. For example, the pre-journey rest processor 225 may search for and/or obtain historic information pertaining to prior user operation scores, prior pre-journey rest scores and/or recommendations (and/or recommendation compliance), and/or prior experience of the user 10 operating any vehicle 14 based on such (or similar) pre-journey information and/or scores. Alternatively or in addition, the pre-journey rest processor 225 may search for and/or obtain historic information pertaining to prior user operation scores, prior pre-journey rest scores and/or recommendations (and/or recommendation compliance), and/or prior experience of the user 10 operating this particular vehicle 14 based on such (or similar) pre-journey information and/or scores. Alternatively or in addition, the pre-journey rest processor 225 may search for and/or obtain historic information pertaining to prior user operation scores, prior pre-journey rest scores and/or recommendations (and/or recommendation compliance), and/or prior experience of the user 10 for this particular journey and/or similar/comparable journeys based on such (or similar) pre-journey information and/or scores.

Based on some or all of the information received by the pre-journey rest processor 225, as described above and in the present disclosure, the pre-journey rest processor 225 is configurable or configured to generate rest scores and/or recommendations for the user 10 for the journey based on such (or similar) pre-journey information and/or scores.

As a non-limiting illustrative example, the pre-journey rest processor 225 may receive pre-journey information and/or scores for a first journey for a first user 10 operating a first vehicle 14, including a pre-journey device activity score, pre-journey biometric score, pre-journey geolocation score, pre-journey hazardous gas score, pre-journey duration score, pre-journey environmental score, and/or pre-journey fuel consumption score. In such an example, the pre-journey rest processor 225 may determine that the first user 10 has a low likelihood of safely, reliably, efficiently, and/or effectively operating the first vehicle 14 for the first journey unless sufficient rest breaks/stops are taken throughout the first journey. Accordingly, the pre-journey rest processor 225 may generate a low pre-journey rest score for the first user 10 operating the first vehicle 14 for the first journey. The pre-journey rest processor 225 may also generate recommendations for the first user 10 to make a specific number of rest stops at specific times and/or locations during the journey, including specific rest durations for each rest stop. For example, the pre-journey rest processor 225 may generate recommendations for a first stop after X1 minutes (or after Y1 km) for X2 minutes, a second stop after X3 minutes (or after Y2 km) for X4 minutes, and so on.

As another non-limiting illustrative example, the pre-journey rest processor 225 may receive pre-journey information and/or scores for a second journey for a second user 10 operating a second vehicle 14, including a pre-journey device activity score, pre-journey biometric score, pre-journey geolocation score, pre-journey hazardous gas score, pre-journey duration score, pre-journey environmental score, and/or pre-journey fuel consumption score. In such an example, the pre-journey rest processor 225 may determine that the second user 10 has a high likelihood of safely, reliably, efficiently, and/or effectively operating the second vehicle 14 without any rest breaks/stops during the second journey. Accordingly, the pre-journey rest processor 225 may generate a high pre-journey rest score for the second user 10 operating the second vehicle 14 for the second journey. The pre-journey rest processor 225 may also generate recommendations for the first user 10 to proceed with the second journey without requiring any rest breaks/stops (or not generate any rest recommendations for the second journey).

### The Pre-Journey Hazardous Gas Processor (e.g., Pre-Journey Hazardous Gas Processor 226)

As illustrated in FIG. 3, the pre-journey processor 220 includes one or more pre-journey hazardous gas processors (e.g., pre-journey hazardous gas processor 226). Each pre-journey hazardous gas processor 226 is configurable or configured to process information pertaining to pre-journey hazardous gas information (i.e., hazardous gas readings obtained for the vehicle 14 before the start of the journey (or before the start time)), as provided by the main interface 210, one or more elements of the processor 200, and/or one or more information sources. As used in the present disclosure, hazardous gas information (or readings) includes, but is not limited to, information pertaining to hazardous gas measurements or readings in the vehicle 14, measurements or readings of hazardous levels of gas (which may or may not be hazardous gases, but may be hazardous when a certain amount of such gas is present) in the vehicle 14, etc. Hazardous gases may include, but are not limited to, carbon monoxide, hydrogen sulphide, sulphur dioxide, hydrogen, nitric oxide, ethanol, ammonia, chlorine, ethylene, etc.

In processing such information, the pre-journey hazardous gas processor 226 is configurable or configured to assess, analyze, and/or predict, among other things, a likelihood that the user 10 can safely, reliably, efficiently, and/or effectively operate the vehicle 14 based on such (or similar) pre-journey hazardous gas information. The pre-journey hazardous gas processor 226 may also perform such assessment, analysis, and/or prediction based on historic information, average information, acceptable/threshold information, benchmark information, etc. For example, the pre-journey hazardous gas processor 226 may search for and/or obtain historic information pertaining to prior user operation scores, prior pre-journey hazardous gas scores, and/or prior experience of the user 10 operating any vehicle 14 based on such (or similar) pre-journey hazardous gas information. Alternatively or in addition, the pre-journey hazardous gas processor 226 may search for and/or obtain historic information pertaining to prior user operation scores, prior pre-journey hazardous gas scores, and/or prior experience of the user 10 operating this particular vehicle 14 based on such (or similar) pre-journey hazardous gas information. Alternatively or in addition, the pre-journey hazardous gas processor 226 may search for and/or obtain historic information pertaining to prior user operation scores, prior pre-journey hazardous gas scores, and/or prior experience of the user 10 for this particular journey and/or similar/comparable journeys based on such (or similar) pre-journey hazardous gas information.

The pre-journey hazardous gas processor 226 is then configurable or configured to assess, analyze, and/or predict, among other things, a likelihood that the user 10 can safely, reliably, efficiently, and/or effectively operate the vehicle 14 based on the pre-journey hazardous gas information and/or such searched for and/or obtained historic information. More specifically, the pre-journey hazardous gas processor 226 is configurable or configured to generate a score, or the like, such as a pre-journey hazardous gas score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey hazardous gas information. For example, the pre-journey hazardous gas information may include information on hazardous gas readings received from a monitoring device installed in the vehicle 14. In such an example, the pre-journey hazardous gas processor 226 may perform assessments of the pre-journey hazardous gas information based on, among other things, the type of gas detected (e.g., carbon monoxide), the concentration of the gas (e.g., in parts per million, or ppm), and time of exposure (or in a case where the user 10 was not present in the vehicle 14, the duration of detection of the gas by the device). As a more specific example, a high pre pre-journey hazardous gas score will be generated when the concentration of gas is less than 25 ppm and time of exposure is less than 8 hours; a medium pre-journey hazardous gas score will be generate when the concentration of gas is between 26-74 ppm and time of exposure is less than 8 hours; and a low pre-journey hazardous gas score, which is indicative or a dangerous situation, will be generated when the concentration of gas is greater than 70 ppm regardless of the time of exposure. In a situation where the pre-journey hazardous gas processor 226 generates a low pre-journey hazardous gas score, one or more elements of the processor 200 (e.g., the response processor 260) will generate one or more responses, including but not limited to, commanding the vehicle 14 to open one or more windows of the vehicle 14, send an emergency notification to the user 10, user device 10, wearable device 12, vehicle 14, control center 16, and/or authority, etc. Other variations, scoring methodology/granularity (e.g., assigning more granular numerical scores based on the combination of the concentration and time of exposure), responses, and factors are also contemplated without departing from the teachings of the present disclosure.

As a non-limiting illustrative example, the pre-journey hazardous gas processor 226 may receive pre-journey hazardous gas information of a first journey for a first user 10 operating a first vehicle 14, including an abnormal or high hazardous gas reading. In such a situation, the pre-journey hazardous gas processor 226 may not be required to perform searches of historic information (since such conditions are dangerous for any user 10). Alternatively, if the pre-journey hazardous gas processor 226 performs searches for historic information, the pre-journey hazardous gas processor 226 may determine that the first user 10 has little or no history/experience for journeys having abnormal or high hazardous gas readings. In such an example, the pre-journey hazardous gas processor 226 may determine that the first user 10 has a low likelihood of safely, reliably, efficiently, and/or effectively operating the first vehicle 14 for the first journey based on the pre-journey hazardous gas information. Accordingly, the pre-journey hazardous gas processor 226 may generate a low pre-journey hazardous gas score for the first user 10 operating the first vehicle 14 for the first journey based on the pre-journey hazardous gas information.

As another non-limiting illustrative example, the pre-journey hazardous gas processor 226 may receive pre-journey hazardous gas information of a second journey for a second user 10 operating a second vehicle 14, including a normal or low hazardous gas reading. In such a situation, the pre-journey hazardous gas processor 226 may not be required to perform searches of historic information (since such conditions are safe for any user 10). Alternatively, if the pre-journey hazardous gas processor 226 performs searches for historic information, the pre-journey hazardous gas processor 226 may determine that the first user 10 has significant or extensive history/experience for journeys having normal or low hazardous gas readings. In such an example, the pre-journey hazardous gas processor 226 may determine that the second user has a high likelihood of safely, reliably, efficiently, and/or effectively operating the second vehicle 14 for the second journey based on the pre-journey hazardous gas information. Accordingly, the pre-journey hazardous gas processor 226 may generate a high pre-journey hazardous gas score for the second user 10 operating the second vehicle 14 for the second journey based on the pre-journey hazardous gas information.

### The Pre-Journey Duration Processor (e.g., Pre-Journey Duration Processor 227)

As illustrated in FIG. 3, the pre-journey processor 220 includes one or more pre-journey duration processors (e.g., pre-journey duration processor 227). Each pre-journey duration processor 227 is configurable or configured to process information pertaining to pre-journey duration information (i.e., total travel time for the journey, as estimated or derived before the start of the journey (or before the start time)), as provided by the main interface 210, one or more elements of the processor 200, and/or one or more information sources. As used in the present disclosure, duration information may also include information pertaining to estimated total travel time for each estimated route (if there are more than one possible routes) for a journey.

In processing such information, the pre-journey duration processor 227 is configurable or configured to assess, analyze, and/or predict, among other things, a likelihood that the user 10 can safely, reliably, efficiently, and/or effectively operate the vehicle 14 based on such (or similar) pre-journey duration information. The pre-journey duration processor 227 may also perform such assessment, analysis, and/or prediction based on historic information, average information, acceptable/threshold information, benchmark information, etc. For example, the pre-journey duration processor 227 may search for and/or obtain historic information pertaining to prior user operation scores, prior pre-journey duration scores, and/or prior experience of the user 10 operating any vehicle 14 based on such (or similar) pre-journey duration information. Alternatively or in addition, the pre-journey duration processor 227 may search for and/or obtain historic information pertaining to prior user operation scores, prior pre-journey duration scores, and/or prior experience of the user 10 operating this particular vehicle 14 based on such (or similar) pre-journey duration information. Alternatively or in addition, the pre-journey duration processor 227 may search for and/or obtain historic information pertaining to prior user operation scores, prior pre-journey duration scores, and/or prior experience of the user 10 for this particular journey and/or similar/comparable journeys based on such (or similar) pre-journey duration information.

The pre-journey duration processor 227 is then configurable or configured to assess, analyze, and/or predict, among other things, a likelihood that the user 10 can safely, reliably, efficiently, and/or effectively operate the vehicle 14 based on the pre-journey duration information and/or such searched for and/or obtained historic information. More specifically, the pre-journey duration processor 227 is configurable or configured to generate a score, or the like, such as a pre-journey duration score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey duration information.

As a non-limiting illustrative example, the pre-journey duration processor 227 may receive pre-journey duration information of a first journey for a first user 10 operating a first vehicle 14, including an estimated total travel time for the first journey of 17 hours (as estimated before the start time). In searching for historic information, the pre-journey duration processor 227 may determine that the first user 10 has little or no history/experience for journeys having an estimated total travel time of 17 hours (e.g., typical total travel time for the first user is 3 hours). In such an example, the pre-journey duration processor 227 may determine that the first user 10 has a low likelihood of safely, reliably, efficiently, and/or effectively operating the first vehicle 14 for the first journey based on the pre-journey duration information. Accordingly, the pre-journey duration processor 227 may generate a low pre-journey duration score for the first user 10 operating the first vehicle 14 for the first journey based on the pre-journey duration information.

As another non-limiting illustrative example, the pre-journey duration processor 227 may receive pre-journey duration information of a second journey for a second user 10 operating a second vehicle 14, including an estimated total travel time for the second journey of hours (as estimated before the start time). In searching for historic information, the pre-journey duration processor 227 may determine that the second user 10 has significant or extensive history/experience for journeys having an estimated total travel time of 5 hours (e.g., typical total travel time for the second user 10 is 7 hours). In such an example, the pre-journey duration processor 227 may determine that the second user 10 has a high likelihood of safely, reliably, efficiently, and/or effectively operating the second vehicle 14 for the second journey based on the pre-journey duration information. Accordingly, the pre-journey duration processor 227 may generate a high pre-journey duration score for the second user 10 operating the second vehicle 14 for the second journey based on the pre-journey duration information.

### The Pre-Journey Environmental Processor (e.g., Pre-Journey Environmental Processor 228)

As illustrated in FIG. 3, the pre-journey processor 220 includes one or more pre-journey environmental processors (e.g., pre-journey environmental processor 228). Each pre-journey environmental processor 228 is configurable or configured to process information pertaining to pre-journey environmental information (i.e., environmental information, as estimated, predicted, or forecasted before the start of the journey (or before the start time)), as provided by the main interface 210, one or more elements of the processor 200, and/or one or more information sources. As used in the present disclosure, environmental information includes, but is not limited to, information pertaining to weather conditions, traffic conditions, road conditions, rainy conditions, sunny conditions, humidity, etc.

In processing such information, the pre-journey environmental processor 228 is configurable or configured to assess, analyze, and/or predict, among other things, a likelihood that the user 10 can safely, reliably, efficiently, and/or effectively operate the vehicle 14 based on such (or similar) pre-journey environmental information. The pre-journey environmental processor 228 may also perform such assessment, analysis, and/or prediction based on historic information, average information, acceptable/threshold information, benchmark information, etc. For example, the pre-journey environmental processor 228 may search for and/or obtain historic information pertaining to prior user operation scores, prior pre-journey environmental scores, and/or prior experience of the user 10 operating any vehicle 14 based on such (or similar) pre-journey environmental information. Alternatively or in addition, the pre-journey environmental processor 228 may search for and/or obtain historic information pertaining to prior user operation scores, prior pre-journey environmental scores, and/or prior experience of the user 10 operating this particular vehicle 14 based on such (or similar) pre-journey environmental information. Alternatively or in addition, the pre-journey environmental processor 228 may search for and/or obtain historic information pertaining to prior user operation scores, prior pre-journey environmental scores, and/or prior experience of the user 10 for this particular journey and/or similar/comparable journeys based on such (or similar) pre-journey environmental information.

The pre-journey environmental processor 228 is then configurable or configured to assess, analyze, and/or predict, among other things, a likelihood that the user 10 can safely, reliably, efficiently, and/or effectively operate the vehicle 14 based on the pre-journey environmental information and/or such searched for and/or obtained historic information. More specifically, the pre-journey environmental processor 228 is configurable or configured to generate a score, or the like, such as a pre-journey environmental score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey environmental information.

As a non-limiting illustrative example, the pre-journey environmental processor 228 may receive pre-journey environmental information of a first journey for a first user 10 operating a first vehicle 14, including weather conditions indicating snow storm conditions with low visibility. In such a situation, the pre-journey environmental processor 228 may not be required to perform searches of historic information (since such conditions are dangerous for any user 10). Alternatively, if the pre-journey environmental processor 228 performs searches for historic information, the pre-journey environmental processor 228 may determine that the first user 10 has little or no history/experience for journeys having such environmental conditions. In such an example, the pre-journey environmental processor 228 may determine that the first user 10 has a low likelihood of safely, reliably, efficiently, and/or effectively operating the first vehicle 14 for the first journey based on the pre-journey environmental information. Accordingly, the pre-journey environmental processor 228 may generate a low pre-journey environmental score for the first user 10 operating the first vehicle 14 for the first journey based on the pre-journey environmental information.

As another non-limiting illustrative example, the pre-journey environmental processor 228 may receive pre-journey environmental information of a second journey for a second user 10 operating a second vehicle 14, including clear weather conditions throughout the journey. In such a situation, the pre-journey environmental processor 228 may not be required to perform searches of historic information (since such conditions are safe for any user 10). Alternatively, if the in-journey environmental processor 238 performs searches for historic information, the pre-journey environmental processor 228 may determine that the second user has significant or extensive history/experience for journeys having clear weather conditions. In such an example, the pre-journey environmental processor 228 may determine that the second user 10 has a high likelihood of safely, reliably, efficiently, and/or effectively operating the second vehicle 14 for the second journey based on the pre-journey environmental information. Accordingly, the pre-journey environmental processor 228 may generate a high pre-journey environmental score for the second user 10 operating the second vehicle 14 for the second journey based on the pre-journey environmental information.

### The Pre-Journey Fuel Consumption Processor (e.g., Pre-Journey Fuel Consumption Processor 229)

As illustrated in FIG. 3, the pre-journey processor 220 includes one or more pre-journey fuel consumption processors (e.g., pre-journey fuel consumption processor 229). Each pre-journey fuel consumption processor 229 is configurable or configured to process information pertaining to pre-journey fuel consumption information (i.e., fuel consumption, as estimated before the start of the journey (or before the start time)), as provided by the main interface 210, one or more elements of the processor 200, and/or one or more information sources. As used in the present disclosure, fuel consumption information (or readings) includes, but is not limited to, information pertaining to current fuel capacity/readings for the vehicle 14, estimated distance that can be travelled for the current fuel capacity/readings, fuel consumption of the vehicle 14, fuel consumption of vehicles driven by the user 14, fuel consumption of vehicles that drive the journey, km/L at previous fueling of vehicle 14.

In processing such information, the pre-journey fuel consumption processor 229 is configurable or configured to assess, analyze, and/or predict, among other things, a likelihood that the user 10 can safely, reliably, efficiently, and/or effectively operate the vehicle 14 based on such (or similar) pre-journey fuel consumption information. The pre-journey fuel consumption processor 229 may also perform such assessment, analysis, and/or prediction based on historic information, average information, acceptable/threshold information, benchmark information, etc. For example, the pre-journey fuel consumption processor 229 may search for and/or obtain historic information pertaining to prior user operation scores, prior pre-journey fuel consumption scores, and/or prior experience of the user 10 operating any vehicle 14 based on such (or similar) pre-journey fuel consumption information. Alternatively or in addition, the pre-journey fuel consumption processor 229 may search for and/or obtain historic information pertaining to prior user operation scores, prior pre-journey fuel consumption scores, and/or prior experience of the user 10 operating this particular vehicle 14 based on such (or similar) pre-journey fuel consumption information. Alternatively or in addition, the pre-journey fuel consumption processor 229 may search for and/or obtain historic information pertaining to prior user operation scores, prior pre-journey fuel consumption scores, and/or prior experience of the user 10 for this particular journey and/or similar/comparable journeys based on such (or similar) pre-journey fuel consumption information.

The pre-journey fuel consumption processor 229 is then configurable or configured to assess, analyze, and/or predict, among other things, a likelihood that the user 10 can safely, reliably, efficiently, and/or effectively operate the vehicle 14 based on the pre-journey fuel consumption information and/or such searched for and/or obtained historic information. More specifically, the pre-journey fuel consumption processor 229 is configurable or configured to generate a score, or the like, such as a pre-journey fuel consumption score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) pre-journey fuel consumption information. For example, the pre-journey fuel consumption information may include information on fuel consumption readings received from a monitoring device installed in the vehicle 14. In such an example, the pre-journey fuel consumption processor 229 may perform assessments of the pre-journey fuel consumption information (and may also consider the historic pre-journey and/or in-journey fuel consumption information) based on, among other things, actual fuel consumption (e.g., km/liter, mpg, etc.), time of reading, idling rate, etc. As a more specific example, a high in pre-journey fuel consumption score will be generated when the fuel consumption is greater than 8 km/L; a medium pre-journey fuel consumption score will be generate when the fuel consumption is between 7-8 km/L; and a low pre-journey fuel consumption score will be generated when the fuel consumption is below 7 km/L. In a situation where the pre-journey fuel consumption processor 229 generates a low pre-journey fuel consumption score, one or more elements of the processor 200 (e.g., the response processor 260) will generate one or more responses, including but not limited to, sending a notification to the user 10, user device 10, wearable device 12, vehicle 14, control center 16, and/or authority and requiring clarification from the user 10, escalating to a supervisor of the user 10, etc. Other variations, scoring methodology/granularity, responses, and factors are also contemplated without departing from the teachings of the present disclosure.

### The In-Journey Processor (e.g., In-Journey Processor 230)

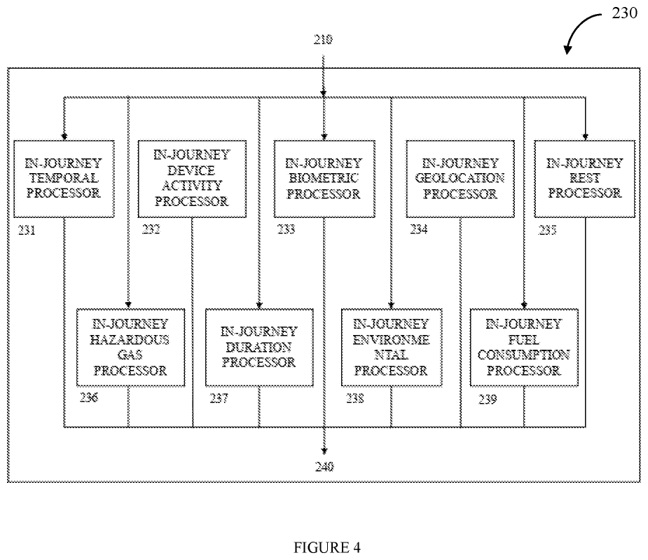

As illustrated in FIG. 2 and FIG. 4, the processor 200 includes one or more in journey processors (e.g., in-journey processor 230). Each in-journey processor 230 is configurable or configured to receive, among other things, in-journey information and/or in-journey information sets from the main interface 210 (and/or directly from one or more information sources). The in-journey processor 230 is then configurable or configured to process such information, and provide such processed information to one or more other elements of the processor 200.

The processing by each in-journey processor 230 may include, but is not limited to, performing a selection of information from among the information received, generating information sets (or information payloads, which may also include scores and/or recommendations), selectively ordering the information sets based on one or more criterion, and providing and/or making available selected/generated information sets to one or more other elements of the processor 200. For example, as further described below and in the present disclosure, the in-journey processor 230 generates a plurality of different information sets, scores, and/or recommendations (e.g., in-journey temporal score, in-journey device activity score, in-journey biometric score, in-journey geolocation score, in-journey rest score and/or recommendation, in hazardous gas score, in duration score, in environmental score, and/or in-journey fuel consumption score) for the user operation score processor 240 to use in generating one or more user operation scores.

To perform the processes, methods, and/or actions described above and in the present disclosure, example embodiments of the in-journey processor 230 include one or more elements. For example, as illustrated in at least FIG. 4, the in-journey processor 230 may include one or more in-journey temporal processors 231 for processing information pertaining to the start time, first time, end time, and/or one or more times between the start time and the end time (e.g., in the form of time of the day, day of the week, and/or day of the month; based on pre-journey and/or in-journey information). The in-journey processor 230 may also include one or more in-journey device activity processors 232 for processing information pertaining to user device 10 usage by the user 10 during the journey (i.e., between the start time and end time, such as at the first time). The in-journey processor 230 may also include one or more in-journey biometric processors 233 for processing information pertaining to biometric information of the user 10 obtained during the journey (i.e., between the start time and end time, such as at the first time). The in-journey processor 230 may also include one or more in-journey geolocation processors 234 for processing information pertaining to present or current locations (e.g., geolocation information of the user device 10, wearable device 12, and/or vehicle 14), estimated distance for the journey, estimated distance travelled so far for the journey, estimated distance remaining for the journey, estimated route information for the journey (including alternative routes), estimated route information already travelled for the journey, estimated route information remaining for the journey (including alternative routes), etc., as determined or estimated during the journey (i.e., between the start time and end time, such as at the first time; based on pre-journey and/or in-journey information). The in-journey processor 230 may also include one or more in-journey rest processors 235 for processing information pertaining to rest recommendations for the user 10 during the journey (i.e., between the start time and end time, such as at the first time; based on pre-journey and/or in-journey information). The in-journey processor 230 may also include one or more in-journey hazardous gas processors 236 for processing information pertaining to a hazardous gas level (and/or hazardous level of gas) within the vehicle 14 of the user 10 obtained during the journey (i.e., between the start time and end time, such as at the first time; based on pre-journey and/or in-journey information). The in-journey processor 230 may also include one or more in-journey duration processors 237 for processing information pertaining to estimated total travel time for the journey, as estimated during the journey (i.e., between the start time and end time, such as at the first time; based on pre-journey and/or in-journey information). The in-journey processor 230 may also include one or more in-journey environmental processors 238 for processing information pertaining to weather conditions, traffic conditions, etc., as estimated during the journey (i.e., between the start time and end time, such as at the first time; based on pre-journey and/or in information). The in-journey processor 230 may also include one or more in-journey fuel consumption processors 239 for processing information pertaining to fuel consumption of the vehicle 14 of the user 10, as estimated during the journey (i.e., between the start time and end time, such as at the first time; based on pre-journey and/or in-journey information).

Although the figures may illustrate one in-journey temporal processors 231, one in-journey device activity processors 232, one in-journey biometric processors 233, one in-journey geolocation processors 234, one in-journey rest processors 235, one in-journey hazardous gas processors 236, one in-journey duration processors 237, one in-journey environmental processors 238, and one in-journey fuel consumption processors 239, it is to be understood that the in-journey processor 230 may include more or less than one in-journey temporal processors 231, more or less than one in-journey device activity processors 232, more or less than one in-journey biometric processors 233, more or less than one in-journey geolocation processors 234, more or less than one in-journey rest processors 235, more or less than one in-journey hazardous gas processors 236, more or less than one in-journey duration processors 237, more or less than one in-journey environmental processors 238, and more or less than one in-journey fuel consumption processors 239 without departing from the teachings of the present disclosure. It is also to be understood in the present disclosure that, although the functions and/or processes performed by the in-journey processor 230 are described in the present disclosure as being performed by particular elements of the in-journey processor 230, the functions and/or processes performed by a particular element of the in-journey processor 230 may also be performed by one or more other elements and/or cooperatively performed by more than one element of the processor 200 without departing from the teachings of the present disclosure. It is also to be understood in the present disclosure that, although the functions and/or processes performed by the in-journey processor 230 are described in the present disclosure as being performed by particular elements of the in-journey processor 230, the functions and/or processes performed by two or more particular elements of the in-journey processor 230 may be combined and performed by one element of the processor 200 without departing from the teachings of the present disclosure. For example, a journey processor may perform some or all of the functions and/or processes of both the pre-journey processor 220 and in-journey processor 230; a temporal processor may perform some or all of the functions and/or processes of both the pre-journey temporal processor 221 and in-journey temporal processor 231; a device activity processor may perform some or all of the functions and/or processes of both the pre-journey device activity processor 222 and in-journey device activity processor 232; a biometric processor may perform some or all of the functions and/or processes of both the pre-journey biometric processor 223 and in-journey biometric processor 233; a geolocation processor may perform some or all of the functions and/or processes of both the pre-journey geolocation processor 224 and in-journey geolocation processor 234; a rest processor may perform some or all of the functions and/or processes of both the pre-journey rest processor 225 and in-journey rest processor 235; a hazardous gas processor may perform some or all of the functions and/or processes of both the pre-journey hazardous gas processor 226 and in-journey hazardous gas processor 236; a duration processor may perform some or all of the functions and/or processes of both the pre-journey duration processor 227 and in-journey duration processor 237; an environmental processor may perform some or all of the functions and/or processes of both the pre-journey environmental processor 228 and in-journey environmental processor 238; and/or a fuel consumption processor may perform some or all of the functions and/or processes of both the pre-journey fuel consumption processor 229 and in-journey fuel consumption processor 239.

These elements of the in-journey processor 230 will now be further described with reference to the accompanying figures.

### The In-Journey Temporal Processor (e.g., In-Journey Temporal Processor 231)

As illustrated in FIG. 4, the in-journey processor 230 includes one or more in-journey temporal processors (e.g., in-journey temporal processor 231). Each in-journey temporal processor 231 is configurable or configured to process information pertaining to an actual start time and/or estimated or expected end time for the journey (which may be in the form of a time of the day, day of the week, and/or day of the month), as provided by the main interface 210, one or more elements of the processor 200, and/or one or more information sources. In some example embodiments, the in-journey temporal processor 231 generates estimated or expected end time(s) for the journey.

In processing such information, the in-journey temporal processor 231 is configurable or configured to assess, analyze, and/or predict, among other things, a likelihood that the user 10 can safely, reliably, efficiently, and/or effectively operate the vehicle 14 throughout the journey (between the start time and end time, including the first time) based on the actual start time and estimated or expected end time (as estimated during the journey, such as at the first time). The in temporal processor 231 may also perform such assessment, analysis, and/or prediction based on historic information, average information, acceptable/threshold information, benchmark information, etc. For example, the in-journey temporal processor 231 may search for and/or obtain historic information pertaining to prior user operation scores, prior in-journey temporal scores, and/or prior experience of the user 10 operating any vehicle 14 based on the actual start time and estimated or expected end time (as estimated during the journey, such as at the first time). Alternatively or in addition, the in-journey temporal processor 231 may search for and/or obtain historic information pertaining to prior user operation scores, prior in-journey temporal scores, and/or prior experience of the user operating this particular vehicle 14 based on the actual start time and estimated or expected end time (as estimated during the journey, such as at the first time). Alternatively or in addition, the in-journey temporal processor 231 may search for and/or obtain historic information pertaining to prior user operation scores, prior in-journey temporal scores, and/or prior experience of the user 10 for this particular journey and/or similar/comparable journeys based on the actual start time and estimated or expected end time (as estimated during the journey, such as at the first time).

The in-journey temporal processor 231 is then configurable or configured to assess, analyze, and/or predict, among other things, a likelihood that the user 10 can safely, reliably, efficiently, and/or effectively operate the vehicle 14 based on the actual start time, estimated or expected end time (as estimated during the journey, such as at the first time), and such searched for and/or obtained historic information. More specifically, the in-journey temporal processor 231 is configurable or configured to generate a score, or the like, such as an in temporal score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on the actual start time and estimated or expected end time (as estimated during the journey, such as at the first time).

As a non-limiting illustrative example, the in-journey temporal processor 231 may identify an actual start time of a first journey for a first user 10 operating a first vehicle 14 to be 3 am on Monday 7 Jun. 2021. Based on the first journey, the in-journey temporal processor 231 may estimate an end time to be Bpm on Monday 7 Jun. 2021. In searching for historic information, the in-journey temporal processor 231 may determine that the first user 10 has little or no history/experience for journeys having a start time of 3 am (e.g., typical start times for the first user 10 on Mondays is 10 am), an end time of Bpm (e.g., typical end times for the first user on Mondays is 1 pm), and a journey duration of 17 hours (e.g., typical journey durations for the first user 10 on Mondays is 3 hours). In such an example, the in-journey temporal processor 231 may determine that the first user 10 has a low likelihood of safely, reliably, efficiently, and/or effectively operating the first vehicle 14 for the first journey based on the actual start time, estimated end time (as estimated during the first journey, such as at the first time), and date of the first journey. Accordingly, the in-journey temporal processor 231 may generate a low in-journey temporal score for the first user 10 operating the first vehicle 14 for the first journey based on the actual start time, estimated end time (as estimated during the first journey, such as at the first time), and date of the first journey.

As another non-limiting illustrative example, the in-journey temporal processor 231 may identify (or receive) an actual start time of a second journey for a second user 10 operating a second vehicle 14 to be 7 am on Wednesday 9 Jun. 2021. Based on the second journey, the in-journey temporal processor 231 may estimate an end time to be 5 pm on Wednesday 9 Jun. 2021. In searching for historic information, the in-journey temporal processor 231 may determine that the second user 10 has significant or extensive history/experience for journeys having a start time of around 7 am (e.g., typical start times for the second user 10 on Wednesdays is 8 am), an end time of 5 pm (e.g., typical end times for the second user 10 on Wednesdays is 6 pm), a journey duration of 10 hours (e.g., typical journey durations for the second user 10 on Wednesdays is 11 hours). In such an example, the in-journey temporal processor 231 may determine that the second user 10 has a high likelihood of safely, reliably, efficiently, and/or effectively operating the second vehicle 14 for the second journey based on the actual start time, estimated end time (as estimated during the second journey, such as at the first time), and date of the second journey. Accordingly, the in-journey temporal processor 231 may generate a high in-journey temporal score for the second user 10 operating the second vehicle 14 for the second journey based on the actual start time, estimated end time (as estimated during the second journey, such as at the first time), and date of the second journey.

### The In-Journey Device Activity Processor (e.g., In-Journey Device Activity Processor 232)

As illustrated in FIG. 4, the in-journey processor 230 includes one or more in-journey device activity processors (e.g., in-journey device activity processor 232). Each in-journey device activity processor 232 is configurable or configured to process information pertaining to in-journey user device 10 usage (i.e., usage of the user device 10 between the start time and the end time, such as at the first time), as provided by the main interface 210, one or more elements of the processor 200, and/or one or more information sources. As used in the present disclosure, user device usage (or user device 10 usage) information includes, but is not limited to, information pertaining to duration of usage of the user device 10, types of apps used on the user device 10, user interactions with the user device 10 (e.g., touches on touchscreen, pressing of buttons, speaking into microphone, speaking to digital assistant, use of camera, etc.), network activity of the user device 10, amount of data transmitted by the user device 10, amount of data received by the user device 10, changes in orientation (and/or movements measurable by an accelerometer, or the like, of the user device 10), etc.

In processing such information, the in-journey device activity processor 232 is configurable or configured to assess, analyze, and/or predict, among other things, a likelihood that the user 10 can safely, reliably, efficiently, and/or effectively operate the vehicle 14 based on such (or similar) in-journey user device 10 usage (or put differently, the likelihood that the user 10 is not distracted due to using the user device 10 while operating the vehicle 14). In this regard, the types of applications used, extent of use of the user device 10, extent of user device interactions by the user 10, etc. will affect such safe, reliable, efficient, and effective operation of the vehicle 14. The in-journey device activity processor 232 may also perform such assessment, analysis, and/or prediction based on historic information, average information, acceptable/threshold information, benchmark information, etc. For example, the in-journey device activity processor 232 may search for and/or obtain historic information pertaining to prior user operation scores, prior in-journey device activity scores, and/or prior experience of the user 10 operating any vehicle 14 based on such (or similar) in-journey user device 10 usage. Alternatively or in addition, the in-journey device activity processor 232 may search for and/or obtain historic information pertaining to prior user operation scores, prior in-journey device activity scores, and/or prior experience of the user 10 operating this particular vehicle 14 based on such (or similar) in-journey user device 10 usage. Alternatively or in addition, the in-journey device activity processor 232 may search for and/or obtain historic information pertaining to prior user operation scores, prior in-journey device activity scores, and/or prior experience of the user 10 for this particular journey and/or similar/comparable journeys based on such (or similar) in-journey user device 10 usage.

The in-journey device activity processor 232 is then configurable or configured to assess, analyze, and/or predict, among other things, a likelihood that the user 10 can safely, reliably, efficiently, and/or effectively operate the vehicle 14 based on the in-journey user device usage information and/or such searched for and/or obtained historic information. More specifically, the in-journey device activity processor 232 is configurable or configured to generate a score, or the like, such as an in-journey device activity score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in-journey user device 10 usage.

As a non-limiting illustrative example, the in-journey device activity processor 232 may receive in-journey device usage information (or device activity information) for a first journey for a first user 10 operating a first vehicle 14. The in-journey device usage information may indicate extensive use of certain applications of the user device 10 during the journey, such as at the first time (e.g., continuously playing content on Netflix, Disney+, Tiktok, YouTube, etc.; playing games, such as Fortnite; and/or continuously streaming stocks and/or cryptocurrencies quotes; etc.). The in-journey device activity processor 232 may determine, based on such user device 10 usage while operating the first vehicle 14, the first user 10 is too distracted to safely, reliably, efficiently, and effectively operating the first vehicle 14, and therefore the first user 10 has a low likelihood of safely, reliably, efficiently, and/or effectively operating the first vehicle 14 for the first journey based on such in-journey device usage. Accordingly, the in-journey device activity processor 232 may generate a low in-journey device activity score for the first user 10 operating the first vehicle 14 for the first journey based on such extensive in-journey device usage.

As another non-limiting illustrative example, the in-journey device activity processor 232 may receive in-journey device usage information (or device activity information) for a second journey for a second user 10 operating a second vehicle 14. The in-journey device usage information may indicate little or no use of the user device 10 during the journey, such as at the first time. In such a situation, the in-journey device activity processor 232 may determine that the second user 10 has not been distracted while operating the second vehicle 14, and therefore the second user 10 has a high likelihood of safely, reliably, efficiently, and/or effectively operating the second vehicle 14 for the second journey based on such little or no in-journey device usage. Accordingly, the in-journey device activity processor 232 may generate a high in-journey device activity score for the second user 10 operating the second vehicle 14 for the second journey based on such little or no in-journey device usage.

### The In-Journey Biometric Processor (e.g., In-Journey Biometric Processor 233)

As illustrated in FIG. 4, the in-journey processor 230 includes one or more in-journey biometric processors (e.g., in-journey biometric processor 233). Each in-journey biometric processor 233 is configurable or configured to process information pertaining to in-journey biometric information (i.e., biometric readings of the user 10 obtained for the user 10 during the journey (or after the start time, such as at the first time)), as provided by the main interface 210, one or more elements of the processor 200, and/or one or more information sources.

In processing such information, the in-journey biometric processor 233 is configurable or configured to assess, analyze, and/or predict, among other things, a likelihood that the user 10 can safely, reliably, efficiently, and/or effectively operate the vehicle 14 based on such (or similar) in-journey biometric information. In this regard, any deviations from normal biometric readings will affect such safe, reliable, efficient, and effective operation of the vehicle 14. The in-journey biometric processor 233 may also perform such assessment, analysis, and/or prediction based on historic information, average information, acceptable/threshold information, benchmark information, etc. For example, the in-journey biometric processor 233 may search for and/or obtain historic information pertaining to prior user operation scores, prior in-journey biometric scores, and/or prior experience of the user 10 operating any vehicle 14 based on such (or similar) in-journey biometric information. Alternatively or in addition, the in-journey biometric processor 233 may search for and/or obtain historic information pertaining to prior user operation scores, prior in-journey biometric scores, and/or prior experience of the user 10 operating this particular vehicle 14 based on such (or similar) in-journey biometric information. Alternatively or in addition, the in-journey biometric processor 233 may search for and/or obtain historic information pertaining to prior user operation scores, prior in-journey biometric scores, and/or prior experience of the user 10 for this particular journey and/or similar/comparable journeys based on such (or similar) in-journey biometric information.

The in-journey biometric processor 233 is then configurable or configured to assess, analyze, and/or predict, among other things, a likelihood that the user 10 can safely, reliably, efficiently, and/or effectively operate the vehicle 14 based on the in-journey biometric information and/or such searched for and/or obtained historic information. More specifically, the in-journey biometric processor 233 is configurable or configured to generate a score, or the like, such as an in-journey biometric score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in-journey biometric information.

As a non-limiting illustrative example, the in-journey biometric processor 233 may receive in biometric information (i.e., biometric readings) for a first journey for a first user 10 operating a first vehicle 14. The in-journey biometric information may indicate abnormal biometric readings for the first user 10 during the journey, such as at the first time (e.g., mismatch in facial features, etc.). The in-journey biometric processor 233 may determine, based on such abnormal biometric readings obtained while the first user 10 is operating the first vehicle 14, the first user 10 is not in a condition to safely, reliably, efficiently, and effectively operating the first vehicle 14, and therefore the first user 10 has a low likelihood of safely, reliably, efficiently, and/or effectively operating the first vehicle 14 for the first journey based on such abnormal in-journey biometric information. Accordingly, the in-journey biometric processor 233 may generate a low in-journey biometric score for the first user 10 operating the first vehicle 14 for the first journey based on such abnormal in-journey biometric information.

As another non-limiting illustrative example, the in-journey biometric processor 233 may receive in-journey biometric information (i.e., biometric readings) for a second journey for a second user 10 operating a second vehicle 14. The in-journey biometric information may indicate normal biometric readings during the journey, such as at the first time. In such a situation, the in-journey biometric processor 233 may determine that the second user 10 is in a condition to safely, reliably, efficiently, and effectively operate the second vehicle 14, and therefore the second user 10 has a high likelihood of safely, reliably, efficiently, and/or effectively operating the second vehicle 14 for the second journey based on such in-journey biometric information. Accordingly, the in-journey biometric processor 233 may generate a high in-journey biometric score for the second user 10 operating the second vehicle 14 for the second journey based on such in-journey biometric information.

### The In-Journey Geolocation Processor (e.g., In-Journey Geolocation Processor 234)

As illustrated in FIG. 4, the in-journey processor 230 includes one or more in-journey geolocation processors (e.g., in-journey geolocation processor 234). Each in-journey geolocation processor 234 is configurable or configured to process information pertaining to in-journey geolocation information (i.e., geolocation information for the journey, as estimated or derived during the journey, such as at the first time), as provided by the main interface 210, one or more elements of the processor 200, and/or one or more information sources. As used in the present disclosure, geolocation information includes, but is not limited to, information pertaining to current location, estimated distance for the journey, estimated distance travelled for the journey, estimated distance remaining for the journey, estimated routes (or route information) for the journey, estimated route travelled for the journey, estimated route remaining for the journey, etc.

In processing such information, the in-journey geolocation processor 234 is configurable or configured to assess, analyze, and/or predict, among other things, a likelihood that the user 10 can safely, reliably, efficiently, and/or effectively operate the vehicle 14 based on such (or similar) in-journey geolocation information. The in-journey geolocation processor 234 may perform such assessment, analysis, and/or prediction based on historic information, average information, acceptable/threshold information, benchmark information, etc. For example, the in-journey geolocation processor 234 may search for and/or obtain historic information pertaining to prior user operation scores, prior in-journey geolocation scores, and/or prior experience of the user 10 operating any vehicle 14 based on such (or similar) in-journey geolocation information. Alternatively or in addition, the in-journey geolocation processor 234 may search for and/or obtain historic information pertaining to prior user operation scores, prior in-journey geolocation scores, and/or prior experience of the user 10 operating this particular vehicle 14 based on such (or similar) in-journey geolocation information. Alternatively or in addition, the in-journey geolocation processor 234 may search for and/or obtain historic information pertaining to prior user operation scores, prior in-journey geolocation scores, and/or prior experience of the user 10 for this particular journey and/or similar/comparable journeys based on such (or similar) in-journey geolocation information.

The in-journey geolocation processor 234 is then configurable or configured to assess, analyze, and/or predict, among other things, a likelihood that the user 10 can safely, reliably, efficiently, and/or effectively operate the vehicle 14 based on the in-journey geolocation information and/or such searched for and/or obtained historic information. More specifically, the in-journey geolocation processor 234 is configurable or configured to generate a score, or the like, such as an in geolocation score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in-journey geolocation information.

As a non-limiting illustrative example, the in-journey geolocation processor 234 may receive in-journey geolocation information of a first journey for a first user 10 operating a first vehicle 14, including an estimated total distance for the first journey of 800 km, estimated total remaining distance for the first journey of 600 km, and an estimated route between current location at the first time and geolocation B. In searching for historic information, the in geolocation processor 234 may determine that the first user 10 has little or no history/experience for journeys having an estimated total distance of 800 km and/or estimated total remaining distance of 600 km (e.g., typical total distances for the first user 10 is 80 km); and little or no history/experience travelling the route between the current location and geolocation B. In such an example, the in geolocation processor 234 may determine that the first user 10 has a low likelihood of safely, reliably, efficiently, and/or effectively operating the first vehicle 14 for the first journey based on the in-journey geolocation information. Accordingly, the in-journey geolocation processor 234 may generate a low in-journey geolocation score for the first user 10 operating the first vehicle 14 for the first journey based on the in-journey geolocation information.

As another non-limiting illustrative example, the in geolocation processor 234 may receive in-journey geolocation information of a second journey for a second user 10 operating a second vehicle 14, including a total distance for the second journey of 30 km and an estimated route between current location at the first time and geolocation D. In searching for historic information, the in-journey geolocation processor 234 may determine that the second user 10 has significant or extensive history/experience for journeys having an estimated total distance of 30 km (e.g., typical total distances for the second user 10 is 50 km); and significant or extensive history/experience travelling the route between the current location and geolocation D (e.g., this is the regular route for the second user 10). In such an example, the in-journey geolocation processor 234 may determine that the second user 10 has a high likelihood of safely, reliably, efficiently, and/or effectively operating the second vehicle 14 for the second journey based on the in-journey geolocation information. Accordingly, the in-journey geolocation processor 234 may generate a high in-journey geolocation score for the second user 10 operating the second vehicle 14 for the second journey based on the in-journey geolocation information.

### The In-Journey Rest Processor (e.g., In-Journey Rest Processor 235)

As illustrated in FIG. 4, the in-journey processor 230 includes one or more in-journey rest processors (e.g., in-journey rest processor 235). Each in-journey rest processor 235 is configurable or configured to generate one or more recommendations on rest stops/breaks for the user 10 during a journey (including when to rest, duration of each rest, quantity of rest stops/breaks, where/geolocation to rest, etc.) so as to ensure the user 10 can safely, reliably, efficiently, and/or effectively operate the vehicle 14 for the journey. The pre-journey rest processor 225 may generate such recommendations based on a plurality of information.

For example, the rest recommendations may be generated based on pre-journey and in-journey information, such as an actual start time for the journey (or in start time), end time for the journey (or in-journey end time, as estimated during by the in-journey temporal processor 231, such as at the first time), pre-journey user device 10 usage (i.e., usage of the user device 10 before the start of the journey (or before the start time), as processed by the pre-journey device activity processor 222), in-journey user device 10 usage (i.e., usage of the user device 10 during the journey (such as at the first time), as processed by the in-journey device activity processor 232), in-journey biometric information (i.e., biometric readings of the user 10 obtained for the user 10 during the journey (such as at the first time), as processed by the in-journey biometric processor 233), in-journey geolocation information (i.e., geolocation information for the journey, as estimated, derived, and/or predicted during the journey (such as at the first time) by the in-journey geolocation processor 234), in-journey duration information (i.e., duration information or total travel time for the journey, as estimated, derived, or predicted during the journey (such as at the first time) by in-journey duration processor 237), in-journey environmental information (i.e., environmental information for the journey, as estimated, derived, or predicted during the journey (such as at the first time) by the in-journey environmental processor 238), in-journey fuel consumption information (i.e., fuel consumption information for the journey, as estimated, derived, or predicted during the journey (such as at the first time) by the in-journey fuel consumption processor 239), and/or in-journey hazardous gas information (i.e., hazardous gas information for the vehicle 14 for the journey, as estimated, derived, or predicted during the journey (such as at the first time) by the in-journey hazardous gas processor 236). Such information may be received from the main interface 210, one or more elements of the processor 200, and/or one or more information sources.

Alternatively or in addition, the rest recommendations may be generated based on one or more scores for the user 10 for the journey, such as the pre-journey rest score generated by the pre-journey rest processor 225, the in-journey rest score generated by the in-journey rest processor 235, the in-journey temporal score generated by the in-journey temporal processor 231, the pre-journey device activity score generated by the pre-journey device activity processor 222, the in-journey device activity score generated by the pre-journey device activity processor 232, the in-journey biometric score generated by the in-journey biometric processor 233, the in-journey geolocation score generated by the in-journey geolocation processor 234, the in-journey hazardous gas score generated by the in-journey hazardous gas processor 236, the in-journey duration score generated by the in-journey duration processor 237, the in-journey environmental score generated by the in-journey environmental processor 238, and/or the in-journey fuel consumption score generated by the in-journey fuel consumption processor 239.

Alternatively or in addition, the rest recommendations may be generated based on historic information, average information, acceptable/threshold information, benchmark information, etc. For example, the in-journey rest processor 235 may search for and/or obtain historic information pertaining to prior user operation scores, prior in-journey rest scores and/or recommendations (and/or recommendation compliance), and/or prior experience of the user 10 operating any vehicle 14 based on such (or similar) in-journey information and/or scores. Alternatively or in addition, the in-journey rest processor 235 may search for and/or obtain historic information pertaining to prior user operation scores, prior in-journey rest scores and/or recommendations (and/or recommendation compliance), and/or prior experience of the user 10 operating this particular vehicle 14 based on such (or similar) in-journey information and/or scores. Alternatively or in addition, the in-journey rest processor 235 may search for and/or obtain historic information pertaining to prior user operation scores, prior in-journey rest scores and/or recommendations (and/or recommendation compliance), and/or prior experience of the user 10 for this particular journey and/or similar/comparable journeys based on such (or similar) in-journey information and/or scores.

Based on some or all of the information received by the in-journey rest processor 235, as described above and in the present disclosure, the in-journey rest processor 235 is configurable or configured to generate rest recommendations, pre-journey rest scores (and/or check pre-journey rest recommendation compliance), and in-journey rest scores for the user 10 for the journey based on such (or similar) in-journey information and/or scores.

As a non-limiting illustrative example, the in-journey rest processor 235 may receive in-journey information and/or scores for a first journey for a first user 10 operating a first vehicle 14, including an in-journey device activity score, pre-journey device activity score, in-journey biometric score, in-journey geolocation score, in-journey hazardous gas score, in-journey duration score, in-journey environmental score, and/or in-journey fuel consumption score. In such an example, the in-journey rest processor 235 may determine that the first user has a low likelihood of safely, reliably, efficiently, and/or effectively operating the first vehicle 14 for the first journey unless sufficient rest breaks/stops are taken throughout the first journey. Accordingly, the in-journey rest processor 235 may generate a low in-journey rest score for the first user 10 operating the first vehicle 14 for the first journey. The in-journey rest processor 235 may also generate recommendations for the first user 10 to make a specific number of rest stops at specific times and/or locations during the journey, including specific rest durations for each rest stop. For example, the in-journey rest processor 235 may generate recommendations for a first stop after X1 minutes (or after Y1 km) for X2 minutes, a second stop after X3 minutes (or after Y2 km) for X4 minutes, and so on.

As another non-limiting illustrative example, the in-journey rest processor 235 may receive in-journey information and/or scores for a second journey for a second user 10 operating a second vehicle 14, including an in-journey device activity score, pre-journey device activity score, in-journey biometric score, in-journey geolocation score, in-journey hazardous gas score, in-journey duration score, in-journey environmental score, and/or in-journey fuel consumption score. In such an example, the in-journey rest processor 235 may determine that the second user 10 has a high likelihood of safely, reliably, efficiently, and/or effectively operating the second vehicle 14 without any rest breaks/stops during the second journey. Accordingly, the in-journey rest processor 235 may generate a high in-journey rest score for the second user 10 operating the second vehicle 14 for the second journey. The in-journey rest processor 235 may also generate recommendations for the first user 10 to proceed with the second journey without requiring any rest breaks/stops (or not generate any rest recommendations for the second journey).

### The In-Journey Hazardous Gas Processor (e.g., In-Journey Hazardous Gas Processor 236)

As illustrated in FIG. 4, the in-journey processor 230 includes one or more in-journey hazardous gas processors (e.g., in-journey hazardous gas processor 236). Each in-journey hazardous gas processor 236 is configurable or configured to process information pertaining to in-journey hazardous gas information (i.e., hazardous gas readings obtained for the vehicle 14 during the journey (such as at the first time)), as provided by the main interface 210, one or more elements of the processor 200, and/or one or more information sources. As used in the present disclosure, hazardous gas information (or readings) includes, but is not limited to, information pertaining to hazardous gas measurements or readings in the vehicle 14, measurements or readings of hazardous levels of gas (which may or may not be hazardous gases, but may be hazardous when a certain amount of such gas is present) in the vehicle 14, etc. Hazardous gases may include, but are not limited to, carbon monoxide, hydrogen sulphide, sulphur dioxide, hydrogen, nitric oxide, ethanol, ammonia, chlorine, ethylene, etc.

In processing such information, the in-journey hazardous gas processor 236 is configurable or configured to assess, analyze, and/or predict, among other things, a likelihood that the user 10 can safely, reliably, efficiently, and/or effectively operate the vehicle 14 based on such (or similar) in-journey hazardous gas information. The in-journey hazardous gas processor 236 may also perform such assessment, analysis, and/or prediction based on historic information, average information, acceptable/threshold information, benchmark information, etc. For example, the in-journey hazardous gas processor 236 may search for and/or obtain historic information pertaining to prior user operation scores, prior in-journey hazardous gas scores, and/or prior experience of the user 10 operating any vehicle 14 based on such (or similar) in journey hazardous gas information. Alternatively or in addition, the in journey hazardous gas processor 236 may search for and/or obtain historic information pertaining to prior user operation scores, prior in-journey hazardous gas scores, and/or prior experience of the user 10 operating this particular vehicle 14 based on such (or similar) in journey hazardous gas information. Alternatively or in addition, the in-journey hazardous gas processor 236 may search for and/or obtain historic information pertaining to prior user operation scores, prior in-journey hazardous gas scores, and/or prior experience of the user 10 for this particular journey and/or similar/comparable journeys based on such (or similar) in journey hazardous gas information.

The in journey hazardous gas processor 236 is then configurable or configured to assess, analyze, and/or predict, among other things, a likelihood that the user 10 can safely, reliably, efficiently, and/or effectively operate the vehicle 14 based on the in journey hazardous gas information and/or such searched for and/or obtained historic information. More specifically, the in journey hazardous gas processor 236 is configurable or configured to generate a score, or the like, such as an in journey hazardous gas score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in journey hazardous gas information. For example, the in journey hazardous gas information may include information on hazardous gas readings received from a monitoring device installed in the vehicle 14. In such an example, the in journey hazardous gas processor 236 may perform assessments of the in journey hazardous gas information (and may also consider the pre-journey hazardous gas information) based on, among other things, the type of gas detected (e.g., carbon monoxide), the concentration of the gas (e.g., in parts per million, or ppm), and time of exposure (which may also include time when the user 10 was not present in the vehicle 14). As a more specific example, a high in pre-journey hazardous gas score will be generated when the concentration of gas is less than 25 ppm and time of exposure is less than 8 hours; a medium in-journey hazardous gas score will be generate when the concentration of gas is between 26-74 ppm and time of exposure is less than 8 hours; and a low in-journey hazardous gas score, which is indicative or a dangerous situation, will be generated when the concentration of gas is greater than 75 ppm regardless of the time of exposure. In a situation where the in-journey hazardous gas processor 236 generates a low in-journey hazardous gas score, one or more elements of the processor 200 (e.g., the response processor 260) will generate one or more responses, including but not limited to, commanding the vehicle 14 to open one or more windows of the vehicle 14, send an emergency notification to the user 10, user device 10, wearable device 12, vehicle 14, control center 16, and/or authority, etc. Other variations, scoring methodology/granularity (e.g., assigning more granular numerical scores based on the combination of the concentration and time of exposure), responses, and factors are also contemplated without departing from the teachings of the present disclosure.

As a non-limiting illustrative example, the in-journey hazardous gas processor 236 may receive in-journey hazardous gas information of a first journey for a first user 10 operating a first vehicle 14, including an abnormal or high hazardous gas reading. In such a situation, the in-journey hazardous gas processor 236 may not be required to perform searches of historic information (since such conditions are dangerous for any user 10). Alternatively, if the in-journey hazardous gas processor 236 performs searches for historic information, the in-journey hazardous gas processor 236 may determine that the first user 10 has little or no history/experience for journeys having abnormal or high hazardous gas readings. In such an example, the in-journey hazardous gas processor 236 may determine that the first user 10 has a low likelihood of safely, reliably, efficiently, and/or effectively operating the first vehicle 14 for the first journey based on the in-journey hazardous gas information. Accordingly, the in-journey hazardous gas processor 236 may generate a low in-journey hazardous gas score for the first user 10 operating the first vehicle 14 for the first journey based on the in-journey hazardous gas information.

As another non-limiting illustrative example, the in-journey hazardous gas processor 236 may receive in-journey hazardous gas information of a second journey for a second user 10 operating a second vehicle 14, including a normal or low hazardous gas reading. In such a situation, the in-journey hazardous gas processor 236 may not be required to perform searches of historic information (since such conditions are safe for any user 10). Alternatively, if the in-journey hazardous gas processor 236 performs searches for historic information, the in-journey hazardous gas processor 236 may determine that the first user 10 has significant or extensive history/experience for journeys having normal or low hazardous gas readings. In such an example, the in-journey hazardous gas processor 236 may determine that the second user 10 has a high likelihood of safely, reliably, efficiently, and/or effectively operating the second vehicle 14 for the second journey based on the in-journey hazardous gas information. Accordingly, the in-journey hazardous gas processor 236 may generate a high in-journey hazardous gas score for the second user 10 operating the second vehicle 14 for the second journey based on the in-journey hazardous gas information.

### The In-Journey Duration Processor (e.g., In-Journey Duration Processor 237)

As illustrated in FIG. 4, the in-journey processor 230 includes one or more in-journey duration processors (e.g., in-journey duration processor 237). Each in-journey duration processor 237 is configurable or configured to process information pertaining to in-journey duration information (i.e., total travel time for the journey, as estimated or derived during the journey (such as at the first time)), as provided by the main interface 210, one or more elements of the processor 200, and/or one or more information sources. As used in the present disclosure, duration information may also include information pertaining to estimated total travel time for each estimated route (if there are more than one possible routes) for a journey.

In processing such information, the in-journey duration processor 237 is configurable or configured to assess, analyze, and/or predict, among other things, a likelihood that the user 10 can safely, reliably, efficiently, and/or effectively operate the vehicle 14 based on such (or similar) in-journey duration information. The in-journey duration processor 237 may also perform such assessment, analysis, and/or prediction based on historic information, average information, acceptable/threshold information, benchmark information, etc. For example, the in-journey duration processor 237 may search for and/or obtain historic information pertaining to prior user operation scores, prior in-journey duration scores, and/or prior experience of the user 10 operating any vehicle 14 based on such (or similar) in-journey duration information. Alternatively or in addition, the in-journey duration processor 237 may search for and/or obtain historic information pertaining to prior user operation scores, prior in-journey duration scores, and/or prior experience of the user 10 operating this particular vehicle 14 based on such (or similar) in-journey duration information. Alternatively or in addition, the in-journey duration processor 237 may search for and/or obtain historic information pertaining to prior user operation scores, prior in-journey duration scores, and/or prior experience of the user 10 for this particular journey and/or similar/comparable journeys based on such (or similar) in-journey duration information.

The in-journey duration processor 237 is then configurable or configured to assess, analyze, and/or predict, among other things, a likelihood that the user 10 can safely, reliably, efficiently, and/or effectively operate the vehicle 14 based on the in-journey duration information and/or such searched for and/or obtained historic information. More specifically, the in-journey duration processor 237 is configurable or configured to generate a score, or the like, such as an in duration score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in-journey duration information.

As a non-limiting illustrative example, the in-journey duration processor 237 may receive in-journey duration information of a first journey for a first user 10 operating a first vehicle 14, including an estimated total travel time for the first journey of 17 hours (as estimated during the journey, such as at the first time). In searching for historic information, the in-journey duration processor 237 may determine that the first user 10 has little or no history/experience for journeys having an estimated total travel time of 17 hours (e.g., typical total travel time for the first user 10 is 3 hours). In such an example, the in-journey duration processor 237 may determine that the first user 10 has a low likelihood of safely, reliably, efficiently, and/or effectively operating the first vehicle 14 for the first journey based on the in-journey duration information. Accordingly, the in-journey duration processor 237 may generate a low in-journey duration score for the first user 10 operating the first vehicle 14 for the first journey based on the in-journey duration information.

As another non-limiting illustrative example, the in-journey duration processor 237 may receive in-journey duration information of a second journey for a second user 10 operating a second vehicle 14, including an estimated total travel time for the second journey of hours (as estimated during the journey, such as at the first time). In searching for historic information, the in-journey duration processor 237 may determine that the second user 10 has significant or extensive history/experience for journeys having an estimated total travel time of hours (e.g., typical total travel time for the second user 10 is 7 hours). In such an example, the in-journey duration processor 237 may determine that the second user 10 has a high likelihood of safely, reliably, efficiently, and/or effectively operating the second vehicle 14 for the second journey based on the in-journey duration information. Accordingly, the in-journey duration processor 237 may generate a high in-journey duration score for the second user 10 operating the second vehicle 14 for the second journey based on the in-journey duration information.

### The In-Journey Environmental Processor (e.g., In-Journey Environmental Processor 238)

As illustrated in FIG. 4, the in-journey processor 230 includes one or more in-journey environmental processors (e.g., in-journey environmental processor 238). Each in-journey environmental processor 238 is configurable or configured to process information pertaining to in-journey environmental information (i.e., environmental information, as estimated, predicted, or forecasted during the journey (such as at the first time)), as provided by the main interface 210, one or more elements of the processor 200, and/or one or more information sources. As used in the present disclosure, environmental information includes, but is not limited to, information pertaining to weather conditions, traffic conditions, road conditions, rainy conditions, sunny conditions, humidity, etc.

In processing such information, the in-journey environmental processor 238 is configurable or configured to assess, analyze, and/or predict, among other things, a likelihood that the user 10 can safely, reliably, efficiently, and/or effectively operate the vehicle 14 based on such (or similar) in-journey environmental information. The in-journey environmental processor 238 may also perform such assessment, analysis, and/or prediction based on historic information, average information, acceptable/threshold information, benchmark information, etc. For example, the in-journey environmental processor 238 may search for and/or obtain historic information pertaining to prior user operation scores, prior in-journey environmental scores, and/or prior experience of the user 10 operating any vehicle 14 based on such (or similar) in-journey environmental information. Alternatively or in addition, the in-journey environmental processor 238 may search for and/or obtain historic information pertaining to prior user operation scores, prior in-journey environmental scores, and/or prior experience of the user 10 operating this particular vehicle 14 based on such (or similar) in-journey environmental information. Alternatively or in addition, the in-journey environmental processor 238 may search for and/or obtain historic information pertaining to prior user operation scores, prior in-journey environmental scores, and/or prior experience of the user 10 for this particular journey and/or similar/comparable journeys based on such (or similar) in-journey environmental information.

The in-journey environmental processor 238 is then configurable or configured to assess, analyze, and/or predict, among other things, a likelihood that the user 10 can safely, reliably, efficiently, and/or effectively operate the vehicle 14 based on the in-journey environmental information and/or such searched for and/or obtained historic information. More specifically, the in-journey environmental processor 238 is configurable or configured to generate a score, or the like, such as an in-journey environmental score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in-journey environmental information.

As a non-limiting illustrative example, the in-journey environmental processor 238 may receive in-journey environmental information of a first journey for a first user 10 operating a first vehicle 14, including weather conditions indicating snow storm conditions with low visibility. In such a situation, the in-journey environmental processor 238 may not be required to perform searches of historic information (since such conditions are dangerous for any user 10). Alternatively, if the in-journey environmental processor 238 performs searches for historic information, the in environmental processor 238 may determine that the first user 10 has little or no history/experience for journeys having such environmental conditions. In such an example, the in-journey environmental processor 238 may determine that the first user 10 has a low likelihood of safely, reliably, efficiently, and/or effectively operating the first vehicle 14 for the first journey based on the in environmental information. Accordingly, the in-journey environmental processor 238 may generate a low in-journey environmental score for the first user 10 operating the first vehicle 14 for the first journey based on the in-journey environmental information.

As another non-limiting illustrative example, the in environmental processor 238 may receive in-journey environmental information of a second journey for a second user 10 operating a second vehicle 14, including clear weather conditions throughout the journey. In such a situation, the in-journey environmental processor 238 may not be required to perform searches of historic information (since such conditions are safe for any user 10). Alternatively, if the in-journey environmental processor 238 performs searches for historic information, the in-journey environmental processor 238 may determine that the second user 10 has significant or extensive history/experience for journeys having clear weather conditions. In such an example, the in-journey environmental processor 238 may determine that the second user 10 has a high likelihood of safely, reliably, efficiently, and/or effectively operating the second vehicle 14 for the second journey based on the in-journey environmental information. Accordingly, the in-journey environmental processor 238 may generate a high in-journey environmental score for the second user 10 operating the second vehicle 14 for the second journey based on the in-journey environmental information.

### The In-Journey Fuel Consumption Processor (e.g., In-Journey Fuel Consumption Processor 239)

As illustrated in FIG. 4, the in-journey processor 230 includes one or more in-journey fuel consumption processors (e.g., in-journey fuel consumption processor 239). Each in-journey fuel consumption processor 239 is configurable or configured to process information pertaining to in-journey fuel consumption information (i.e., fuel consumption, as estimated during the journey (such as at the first time)), as provided by the main interface 210, one or more elements of the processor 200, and/or one or more information sources. As used in the present disclosure, fuel consumption information (or readings) includes, but is not limited to, information pertaining to current fuel capacity/readings for the vehicle 14, estimated distance that can be travelled for the current fuel capacity/readings, fuel consumption of the vehicle 14, fuel consumption of vehicles driven by the user 14, fuel consumption of vehicles that drive the journey, etc.

In processing such information, the in-journey fuel consumption processor 239 is configurable or configured to assess, analyze, and/or predict, among other things, a likelihood that the user 10 can safely, reliably, efficiently, and/or effectively operate the vehicle 14 based on such (or similar) in-journey fuel consumption information. The in-journey fuel consumption processor 239 may also perform such assessment, analysis, and/or prediction based on historic information, average information, acceptable/threshold information, benchmark information, etc. For example, the in-journey fuel consumption processor 239 may search for and/or obtain historic information pertaining to prior user operation scores, prior in-journey fuel consumption scores, and/or prior experience of the user 10 operating any vehicle 14 based on such (or similar) in fuel consumption information. Alternatively or in addition, the in fuel consumption processor 239 may search for and/or obtain historic information pertaining to prior user operation scores, prior in-journey fuel consumption scores, and/or prior experience of the user 10 operating this particular vehicle 14 based on such (or similar) in-journey fuel consumption information. Alternatively or in addition, the in-journey fuel consumption processor 239 may search for and/or obtain historic information pertaining to prior user operation scores, prior in-journey fuel consumption scores, and/or prior experience of the user for this particular journey and/or similar/comparable journeys based on such (or similar) in-journey fuel consumption information.

The in-journey fuel consumption processor 239 is then configurable or configured to assess, analyze, and/or predict, among other things, a likelihood that the user 10 can safely, reliably, efficiently, and/or effectively operate the vehicle 14 based on the in-journey fuel consumption information and/or such searched for and/or obtained historic information. More specifically, the in-journey fuel consumption processor 239 is configurable or configured to generate a score, or the like, such as an in-journey fuel consumption score, that represents a likelihood that the user 10 (using the user device 10) can safely, reliably, efficiently, and/or effectively operate a vehicle (or this particular vehicle 14 and/or similar/comparable vehicles) for a journey (or this particular journey and/or similar/comparable journeys) based on such (or similar) in-journey fuel consumption information. For example, the in-journey fuel consumption information may include information on fuel consumption readings received from a monitoring device installed in the vehicle 14. In such an example, the in fuel consumption processor 239 may perform assessments of the in-journey fuel consumption information (and may also consider the pre-journey fuel consumption information) based on, among other things, actual fuel consumption (e.g., km/liter, mpg, etc.), time of reading, idling rate, etc. As a more specific example, a high in in-journey fuel consumption score will be generated when the fuel consumption is greater than 10 km/L; a medium in-journey fuel consumption score will be generate when the fuel consumption is between 7-10 km/L; and a low in-journey fuel consumption score will be generated when the fuel consumption is below 7 km/L. In a situation where the in-journey fuel consumption processor 239 generates a low in-journey fuel consumption score, one or more elements of the processor 200 (e.g., the response processor 260) will generate one or more responses, including but not limited to, sending a notification to the user 10, user device 10, wearable device 12, vehicle 14, control center 16, and/or authority and requiring clarification from the user 10, escalating to a supervisor of the user 10, etc. Other variations, scoring methodology/granularity, responses, and factors are also contemplated without departing from the teachings of the present disclosure.

### The User Operation Score Processor (e.g., User Operation Score Processor 240)

As illustrated in FIG. 2, the processor 200 includes one or more user operation score processors (e.g., user operation score processor 240). Each user operation score processor 240 is configurable or configured to generate user operation scores at various times and based on various information.

For example, the user operation score processor 240 is configurable or configured to generate a pre-journey user operation score (also referred to herein as a user operation score) for a user 10 for a journey based on pre-journey information and/or scores. The pre-journey user operation score can be generated and/or provided to the response processor 260 (and/or directly to the user 10, user device 10, wearable device 12, vehicle 14, control center 16, and/or authority) prior to the start of a journey (i.e., before the start time of a journey) or after the start of the journey. It is recognized in the present disclosure, however, that the pre-journey user operation score is preferably generated and provided to the response processor 260 (and/or directly to the user 10, user device 10, wearable device 12, vehicle 14, control center 16, and/or authority) prior to the start of the journey (i.e., before the start time of the journey) so as to ensure the user 10 (and/or user device 10, wearable device 12, vehicle 14, control center 16, and/or authority) is notified regarding pre-journey rest recommendations and/or pre-journey likelihoods that the user 10 (using the user device 10) can (or cannot) safely, reliably, efficiently, and/or effectively operate a vehicle (or this particular vehicle 14 and/or similar/comparable vehicles) for a journey (or this particular journey and/or similar/comparable journeys) based on such (or similar) pre-journey information and/or scores. In an example embodiment, the user operation score processor 240 generates the pre-journey user operation score based on one or more pre-journey scores for the user 10 for the journey, including the pre-journey temporal score generated by the pre-journey temporal processor 221, the pre-journey device activity score generated by the pre-journey device activity processor 222, the pre-journey biometric score generated by the pre-journey biometric processor 223, the pre-journey geolocation score generated by the pre-journey geolocation processor 224, the pre-journey rest score generated by the pre-journey rest processor 225, the pre-journey hazardous gas score generated by the pre-journey hazardous gas processor 226, the pre-journey duration score generated by the pre-journey duration processor 227, the pre-journey environmental score generated by the pre-journey environmental processor 228, and/or the pre-journey fuel consumption score generated by the pre-journey fuel consumption processor 229. In generating the pre-journey user operation score, each of the pre-journey scores may be assigned an equal weight. It is recognized in the present disclosure, however, that different weighting may be assigned to different pre-journey scores. As a non-limiting example, a low pre-journey temporal score, which is indicative of a user 10 having little or no experience operating the vehicle 14 at such estimated times (start time, end time, and times between the start time and end time, as estimated before commencing on the journey), may be given a greater weight than the weight of a high pre-journey temporal score. Similarly, a low pre-journey device activity score, which is indicative of a user 10 extensively using the user device 10 prior to and/or leading up to the start time, may be given a greater weight than the weight of a high pre-journey device activity score. Similarly, a low pre-journey biometric score, which is indicative of a user 10 having abnormal biometric readings before commencing on the journey, may be given a greater weight than the weight of a high pre-journey biometric score. Furthermore, a low pre-journey biometric score may be given a greater weight than the weight of a low pre-journey temporal score, low pre-journey device activity score, low pre-journey geolocation score, and/or low pre-journey low duration score. Similarly, a low pre-journey geolocation score, which is indicative of very long estimated travel distance (as estimated before commencing on the journey) as compared to what the user 10 is used to traveling, may be given a greater weight than the weight of a high pre-journey geolocation score. Similarly, a low pre-journey hazardous gas score, which is indicative of abnormally high levels of hazardous gas in the vehicle 14 (as determined before commencing on the journey), may be given a greater weight than the weight of a high pre-journey hazardous gas score. Furthermore, a low pre-journey hazardous gas score may be given a greater weight than the weight of a low pre-journey temporal score, low pre-journey device activity score, low pre-journey geolocation score, and/or low pre-journey duration score. Similarly, a low pre-journey duration score, which is indicative of very long estimated travel time (as estimated before commencing on the journey) as compared to what the user 10 is used to traveling, may be given a greater weight than the weight of a high pre-journey duration score. Similarly, a low pre-journey environmental score, which is indicative of dangerous traveling conditions (as forecasted before commencing on the journey), may be given a greater weight than the weight of a high pre-journey environmental score. Furthermore, a low pre-journey environmental score may be given a greater weight than the weight of a low pre-journey temporal score, low pre-journey device activity score, low pre-journey geolocation score, and/or low pre-journey duration score. In example embodiments, the weighting of one or more of the pre-journey scores may be dynamically generated based on, among other things, the user 10, user device 10, journey, vehicle 14, and/or one or more of the pre-journey information. It is recognized in the present disclosure that a low pre-journey biometric score, low pre-journey hazardous gas score, and/or low pre-journey environmental score should result in the overall user operation score to be low, which may be sufficient for the response processor 260 to send a notification to the user 10 (and/or user device 10, wearable device 12, vehicle 14, control center 16, and/or authority) to abort or not proceed with the journey (and/or a control signal to the vehicle 14 to control and/or stop operations of the vehicle 14).

As another example, the user operation score processor 240 is configurable or configured to generate an in-journey user operation score (also referred to herein as a user operation score) for a user 10 for a journey based on in-journey information and/or scores (and may also be based on one or more pre-journey information and/or scores). The in-journey user operation score can be generated and/or provided to the response processor 260 (and/or directly to the user 10, user device 10, wearable device 12, vehicle 14, control center 16, and/or authority) at any time during the journey (e.g., at the first time, which as described in the present disclosure is a time between the start time and the end time). It is recognized in the present disclosure, however, that the in-journey user operation score is preferably generated and provided to the response processor 260 (and/or directly to the user 10, user device 10, wearable device 12, vehicle 14, control center 16, and/or authority) when the in-journey user operation score is below a certain threshold score and/or one or more of the in-journey scores are below a certain threshold score so as to ensure the user 10 (and/or user device 10, wearable device 12, vehicle 14, control center 16, and/or authority) is notified regarding in-journey rest recommendations and/or in-journey likelihoods that the user 10 (using the user device 10) can (or cannot) safely, reliably, efficiently, and/or effectively operate a vehicle (or this particular vehicle 14 and/or similar/comparable vehicles) for a journey (or this particular journey and/or similar/comparable journeys) based on such (or similar) in-journey information and/or scores (and may also be based on one or more pre-journey information and/or scores). In an example embodiment, the user operation score processor 240 generates the in-journey user operation score based on one or more in-journey scores (and may also be based on one or more pre-journey scores) for the user 10 for the journey, including the in-journey temporal score generated by the in-journey temporal processor 231, the in-journey device activity score generated by the in-journey device activity processor 232, the pre-journey device activity score generated by the pre-journey device activity processor 222, the in-journey biometric score generated by the in-journey biometric processor 233, the pre-journey biometric score generated by the pre-journey biometric processor 223, the in-journey geolocation score generated by the in-journey geolocation processor 234, the in-journey rest score generated by the in-journey rest processor 235, the in-journey hazardous gas score generated by the in-journey hazardous gas processor 236, the pre-journey hazardous gas score generated by the pre-journey hazardous gas processor 226, the in-journey duration score generated by the in-journey duration processor 237, the in-journey environmental score generated by the in-journey environmental processor 238, and/or the in-journey fuel consumption score generated by the in-journey fuel consumption processor 239. In generating the in-journey user operation score, each of these scores may be assigned an equal weight. It is recognized in the present disclosure, however, that different weighting may be assigned to different scores. As a non-limiting example, a low in-journey temporal score, which is indicative of a user 10 having little or no experience operating the vehicle 14 at such times (start time, end time, and times between the start time and end time, as estimated during the journey, such as at the first time), may be given a greater weight than the weight of a high in-journey temporal score. Similarly, a low in-journey device activity score, which is indicative of a user 10 extensively using the user device 10 while operating the vehicle 14, may be given a greater weight than the weight of a high in-journey device activity score. Similarly, a low in-journey biometric score, which is indicative of a user 10 having abnormal biometric readings during the journey, may be given a greater weight than the weight of a high in biometric score. Furthermore, a low in-journey biometric score may be given a greater weight than the weight of a low in-journey temporal score, low in-journey device activity score, low in-journey geolocation score, and/or low in-journey low duration score. Similarly, a low in-journey geolocation score, which is indicative of very long estimated travel distance (as estimated during the journey, such as at the first time) as compared to what the user 10 is used to traveling, may be given a greater weight than the weight of a high in-journey geolocation score. Similarly, a low in-journey hazardous gas score, which is indicative of abnormally high levels of hazardous gas in the vehicle 14 (as measured during the journey, such as at the first time), may be given a greater weight than the weight of a high in hazardous gas score. Furthermore, a low in-journey hazardous gas score may be given a greater weight than the weight of a low in temporal score, low in-journey device activity score, low in-journey geolocation score, and/or low in-journey duration score. Similarly, a low in-journey duration score, which is indicative of very long estimated travel time (as estimated during the journey, such as at the first time) as compared to what the user 10 is used to traveling, may be given a greater weight than the weight of a high in-journey duration score. Similarly, a low in-journey environmental score, which is indicative of dangerous traveling conditions (as forecasted during the journey, such as at the first time), may be given a greater weight than the weight of a high in-journey environmental score. Furthermore, a low in-journey environmental score may be given a greater weight than the weight of a low in-journey temporal score, low in-journey device activity score, low in-journey geolocation score, and/or low in-journey duration score. In example embodiments, the weighting of one or more of the in-journey scores may be dynamically generated based on, among other things, the user 10, user device 10, journey, vehicle 14, and/or one or more of the in information. It is recognized in the present disclosure that a low in biometric score, low in journey hazardous gas score, and/or low in-journey environmental score will result in the overall user operation score to be low, which may be sufficient for the response processor 260 to send a notification to the user 10 (and/or user device 10, wearable device 12, vehicle 14, control center 16, and/or authority) to abort or not continue with the journey.

As another example, the user operation score processor 240 is configurable or configured to generate an after journey user operation score (also referred to herein as a user operation score) for a user 10 for a journey based on after journey information and/or scores (and may also be based on one or more in journey information and/or scores and/or one or more pre-journey information and/or scores). The after-journey user operation score can be generated and/or provided to the response processor 260 (and/or directly to the user 10, user device 10, wearable device 12, vehicle 14, control center 16, and/or authority) at any time after the journey. In an example embodiment, the user operation score processor 240 generates the after journey user operation score based on one or more after journey scores (and may also be based on one or more in journey and/or pre-journey scores) for the user 10 for the journey. Such after journey scores may be generated similarly to the pre-journey scores and/or in-journey scores, as described in the present disclosure. For example, after-journey scores may include, but are not limited to, an after journey temporal score (e.g., a score reflecting temporal results of the journey, such as actual time of day and/or day of week/month/year vs. predicted/estimated time of day and/or day of week/month/year), an after-journey device activity score (e.g., a score reflecting device activity results during the journey, such as actual device activity vs. predicted/estimated device activity), an after journey biometric score (e.g., a score reflecting biometric readings during the journey, such as actual biometric readings vs. predicted/estimated biometric readings), an after journey geolocation score (e.g., a score reflecting geolocation results of the journey, such as actual distance travelled and/or routes taken vs. predicted/estimated distance travelled and/or routes taken), an after journey rest score (e.g., a score reflecting rests taken during the journey, such as actual rests taken vs. estimated/predicted/recommended rests), an after journey hazardous gas score (e.g., a score reflecting hazardous gas readings during the journey, such as actual hazardous gas readings vs. estimated/predicted hazardous gas readings), an after-journey duration score (e.g., a score reflecting time and duration results for the journey, such as actual time spent vs. estimated/predicted time spent), an after-journey environmental score (e.g., a score reflecting environmental readings during the journey, such as actual environmental conditions vs. estimated/predicted environmental conditions), an after-journey fuel consumption score (e.g., a score reflecting fuel consumption during the journey, such as actual fuel consumption vs. estimated/predicted fuel consumption), an after journey SOS score (e.g., a score reflecting a likelihood that a user has fallen and/or been injured based on, among other things, user and/or vehicle idling time, SOS timer, response (or lack of response) of user, etc.; in which case, the response processor 260 may initiate an SOS auto assist, or the like, when the response processor 260 and/or any other element of the processor 200 determines that the user is likely to have fallen and/or been injured), and/or an after journey HSE score (e.g., a score reflecting compliance, conformity, and/or practice of current health, safety, and/or environment procedures when a user has reached one or more destinations along the journey and/or at the end of the journey). In generating the after journey user operation score, each of these scores may be assigned an equal weight. It is recognized in the present disclosure, however, that different weighting may be assigned to different scores. As a non-limiting example, a low after-journey temporal score, which is indicative of a user 10 having little or no experience operating the vehicle 14 at such times (start time, end time, and times between the start time and end time), may be given a greater weight than the weight of a high after-journey temporal score. Similarly, a low after journey device activity score, which is indicative of a user 10 extensively using the user device 10 while operating the vehicle 14, may be given a greater weight than the weight of a high after journey device activity score. In example embodiments, the weighting of one or more of the after journey scores may be dynamically generated based on, among other things, the user 10, user device 10, journey, vehicle 14, and/or one or more of the after journey information.

### The Threshold Generator (e.g., Threshold Generator 250)

As illustrated in FIG. 2, the processor 200 includes one or more threshold generators (e.g., threshold generator 250). Each threshold generator 250 may be configurable or configured to generate threshold values for the user operation score processor 240 and/or one or more other elements of the processor 200. Such threshold values are used by the user operation score processor 240 to determine whether or not a score is considered to be high or low (and/or other relative levels or granularity, as required). Such threshold values may also be used by the user operation score processor 240 to determine appropriate weighting for each score. The threshold values may be predetermined and/or equal for all scores and for all weighting. Alternatively, the threshold values may be different for one or more scores and/or one or more weightings. Alternatively, the threshold values may be dynamically generated based on, among other things, the user 10, user device 10, journey, vehicle 14, one or more of the pre-journey information, score, and/or weighting.

### The Response Processor (e.g., Response Processor 260)

As illustrated in FIG. 2, the processor 200 includes one or more response processors (e.g., response processor 260). Each response processor 260 is configurable or configured to receive scores, including pre-journey user operation scores, in-journey user operation scores, and user operation scores, from the user operation score processor. The response processor 260 is also configurable or configured to receive individual scores, including the pre-journey temporal score generated by the pre-journey temporal processor 221, the pre-journey device activity score generated by the pre-journey device activity processor 222, the pre-journey biometric score generated by the pre-journey biometric processor 223, the pre-journey geolocation score generated by the pre-journey geolocation processor 224, the pre-journey rest score generated by the pre-journey rest processor 225, the pre-journey hazardous gas score generated by the pre-journey hazardous gas processor 226, the pre-journey duration score generated by the pre-journey duration processor 227, the pre-journey environmental score generated by the pre-journey environmental processor 228, the pre-journey fuel consumption score generated by the pre-journey fuel consumption processor 229, the in-journey temporal score generated by the in-journey temporal processor 231, the in-journey device activity score generated by the in-journey device activity processor 232, the pre-journey device activity score generated by the pre-journey device activity processor 222, the in-journey biometric score generated by the in-journey biometric processor 233, the pre-journey biometric score generated by the pre-journey biometric processor 223, the in-journey geolocation score generated by the in-journey geolocation processor 234, the in-journey rest score generated by the in-journey rest processor 235, the in-journey hazardous gas score generated by the in-journey hazardous gas processor 236, the pre-journey hazardous gas score generated by the pre-journey hazardous gas processor 226, the in-journey duration score generated by the in-journey duration processor 237, the in-journey environmental score generated by the in-journey environmental processor 238, and/or the in-journey fuel consumption score generated by the in-journey fuel consumption processor 239. The response processor 260 is also configurable or configured to receive rest recommendations, including pre-journey rest recommendations and in-journey rest recommendations, from the user operation score processor 240, the pre-journey rest processor 225, and/or the in-journey rest processor 235.

The response processor 260 is then configurable or configured to generate and send notifications and/or updates to the user 10, user device 10, wearable device 12, vehicle 14, control center 16, and/or authority. In example embodiments when the response processor 260 determines, based on one or more scores received, that a user 10 is operating a vehicle 14 (e.g., during a journey) in an unsafe, improper, inefficient, and/or otherwise abnormal manner, the response processor 260 is configurable or configured to perform, among other things, one or more of the following: prevent the user's 10 operation of the vehicle 14 and/or user device 10 during the journey; control the user's 10 operation of the vehicle 14 and/or user device 10 during the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.); revoke authorization of the user's 10 operation of the vehicle 14 and/or user device 10 during the journey. Similarly, in situations where the response processor 260 determines there is a likelihood (e.g., greater than a predetermined or dynamically determined threshold value, as generated by the threshold generator 250) that a user 10 is unable and/or will not be able to operate a vehicle 14 (either for a part of or the entire journey) in a safe, proper, efficient, and/or normal manner, the response processor 260 is also configurable or configured to perform, among other things, one or more of the following: prevent the user's 10 operation of the vehicle 14 and/or user device 10 prior to the journey; control the user's 10 operation of the vehicle 14 and/or user device 10 prior to the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.), and/or revoke authorization of the user's 10 operation of the vehicle 14 and/or user device 10 prior to the journey.

### Example Embodiments of a Method for Managing User Vehicular Operation, Activity, and Safety (e.g., Method 500)

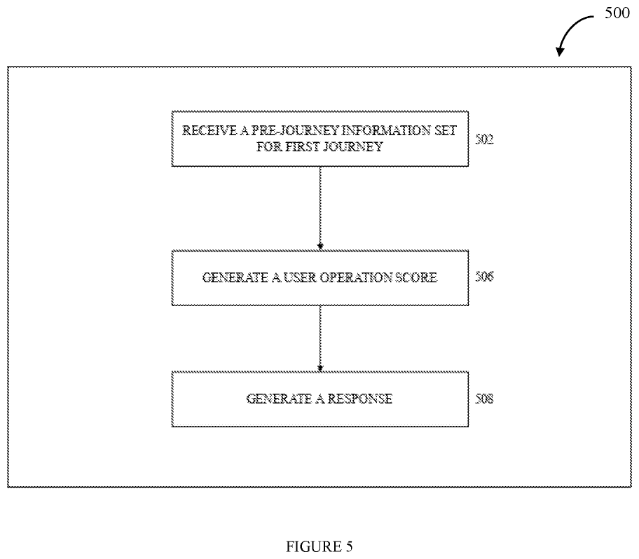

FIG. 5 illustrates an example embodiment of a method (e.g., method 500) for managing user vehicular operation, activity, and safety. One or more of the actions of method 500 may be performed by one or more elements of the processor 200, as described in the present disclosure.

In an example embodiment, the method 500 includes receiving a pre-journey information set (and/or pre-journey information) for a first journey (e.g., action 502). Such pre-journey information set may include one or more pre-journey information, as described above and in the present disclosure. For example, the pre-journey information may include pre-journey temporal information, pre-journey device activity information, pre-journey biometric information, pre-journey geolocation information, pre-journey rest information, pre-journey hazardous gas information, pre-journey duration information, pre-journey environmental information, and/or pre-journey fuel consumption information. The method 500 also includes generating a user operation score (e.g., action 506). The user operation score may be generated based on the received pre-journey information set, as described above and in the present disclosure. For example, the user operation score may be generated based on pre-journey temporal information, pre-journey device activity information, pre-journey biometric information, pre-journey geolocation information, pre-journey rest information, pre-journey hazardous gas information, pre-journey duration information, pre-journey environmental information, and/or pre-journey fuel consumption information. In generating the user operation score, the method 500 may also include generating pre-journey rest recommendations and/or in-journey rest recommendations, as described above and in the present disclosure. The method 500 also includes generating one or more responses (e.g., action 508). Each response may be generated based on the generated user operation score, as described above and in the present disclosure. For example, the response may include notifications (e.g., via messaging, alerts, audio, vibrations, etc.) and/or updates to the user 10, user device 10, wearable device 12, vehicle 14, control center 16, and/or authority. In example embodiments when the method 500 determines that a user operation is unsafe, improper, inefficient, and/or ineffective based on the user operation score, the method 500 may include performing, among other things, one or more of the following: prevent the user's 10 operation of the vehicle 14 and/or user device 10 during the journey; control the user's 10 operation of the vehicle 14 and/or user device 10 during the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.); revoke authorization of the user's operation of the vehicle 14 and/or user device 10 during the journey. Similarly, in example embodiments when the method 500 determines there is a likelihood (e.g., greater than a predetermined or dynamically determined threshold value) that a user 10 is unable and/or will not be able to operate a vehicle 14 (either for a part of or the entire journey) in a safe, proper, efficient, and/or normal manner, the method 500 may include performing, among other things, one or more of the following: prevent the user's 10 operation of the vehicle 14 and/or user device prior to the journey; control the user's 10 operation of the vehicle 14 and/or user device 10 prior to the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.), and/or revoke authorization of the user's 10 operation of the vehicle 14 and/or user device 10 prior to the journey.

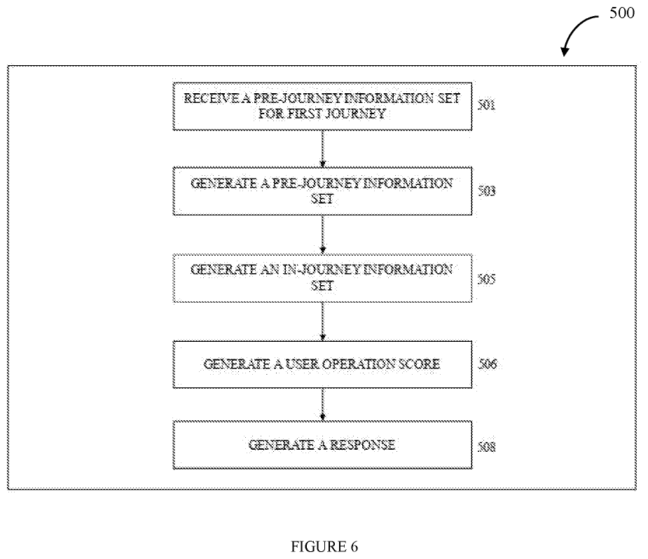

In another example embodiment illustrated in FIG. 6, the method 500 may include receiving pre-journey information for a journey (e.g., action 501) and generating a pre-journey information set based on the received pre-journey information (e.g., action 502). The method 500 also includes generating an in-journey information set 505. Such in-journey information set may include one or more in-journey information, as described above and in the present disclosure. For example, the in-journey information may include in-journey temporal information, in-journey device activity information, in-journey biometric information, in-journey geolocation information, in-journey rest information, in-journey hazardous gas information, in-journey duration information, in-journey environmental information, and/or in-journey fuel consumption information. The method 500 also includes generating a user operation score (e.g., action 506). The user operation score may be generated based on the pre-journey information set and in journey information set, as described above and in the present disclosure. For example, the user operation score may be generated based on pre-journey temporal information, pre-journey device activity information, pre-journey biometric information, pre-journey geolocation information, pre-journey rest information, pre-journey hazardous gas information, pre-journey duration information, pre-journey environmental information, pre-journey fuel consumption information, in-journey temporal information, in-journey device activity information, in-journey biometric information, in-journey geolocation information, in-journey rest information, in-journey hazardous gas information, in-journey duration information, in-journey environmental information, and/or in-journey fuel consumption information. In generating the user operation score, the method 500 may also include generating pre-journey rest recommendations and/or in-journey rest recommendations, as described above and in the present disclosure. The method 500 also includes generating one or more responses (e.g., action 508). Each response may be generated based on the generated user operation score, as described above and in the present disclosure. For example, the response may include notifications and/or updates to the user 10, user device 10, wearable device 12, vehicle 14, control center 16, and/or authority. In example embodiments when the method 500 determines that a user operation is unsafe, improper, inefficient, and/or ineffective based on the user operation score, the method 500 may include performing, among other things, one or more of the following: prevent the user's 10 operation of the vehicle 14 and/or user device 10 during the journey; control the user's 10 operation of the vehicle 14 and/or user device 10 during the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.); revoke authorization of the user's operation of the vehicle 14 and/or user device 10 during the journey. Similarly, in example embodiments when the method 500 determines there is a likelihood (e.g., greater than a predetermined or dynamically determined threshold value) that a user 10 is unable and/or will not be able to operate a vehicle 14 (either for a part of or the entire journey) in a safe, proper, efficient, and/or normal manner, the method 500 may include performing, among other things, one or more of the following: prevent the user's 10 operation of the vehicle 14 and/or user device prior to the journey; control the user's 10 operation of the vehicle 14 and/or user device 10 prior to the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.), and/or revoke authorization of the user's 10 operation of the vehicle 14 and/or user device 10 prior to the journey.

In another example embodiment, the method 500 may include receiving in-journey information for a journey and generating an in-journey information set based on the received in-journey information. Such in-journey information set may include one or more in-journey information, as described above and in the present disclosure. For example, the in-journey information may include in-journey temporal information, in-journey device activity information, in-journey biometric information, in-journey geolocation information, in-journey rest information, in hazardous gas information, in duration information, in-journey environmental information, and/or in-journey fuel consumption information. The method 500 also includes generating a user operation score (e.g., action 506). The user operation score may be generated based on the in-journey information set, as described above and in the present disclosure. For example, the user operation score may be generated based on in-journey temporal information, in-journey device activity information, in-journey biometric information, in geolocation information, in rest information, in hazardous gas information, in-journey duration information, in-journey environmental information, and/or in-journey fuel consumption information. In generating the user operation score, the method 500 may also include generating in-journey rest recommendations, as described above and in the present disclosure. The method 500 also includes generating one or more responses (e.g., action 508). Each response may be generated based on the generated user operation score, as described above and in the present disclosure. For example, the response may include notifications and/or updates to the user 10, user device 10, wearable device 12, vehicle 14, control center 16, and/or authority. In example embodiments when the method 500 determines that a user operation is unsafe, improper, inefficient, and/or ineffective based on the user operation score, the method 500 may include performing, among other things, one or more of the following: prevent the user's 10 operation of the vehicle 14 and/or user device 10 during the journey; control the user's operation of the vehicle 14 and/or user device 10 during the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.); revoke authorization of the user's 10 operation of the vehicle 14 and/or user device 10 during the journey. Similarly, in example embodiments when the method 500 determines there is a likelihood (e.g., greater than a predetermined or dynamically determined threshold value) that a user 10 is unable and/or will not be able to operate a vehicle 14 (either for a part of or the entire journey) in a safe, proper, efficient, and/or normal manner, the method 500 may include performing, among other things, one or more of the following: prevent the user's 10 operation of the vehicle 14 and/or user device 10 prior to the journey; control the user's 10 operation of the vehicle 14 and/or user device 10 prior to the journey (and/or reducing or removing the user's 10 ability to control and/or operate the vehicle 14; e.g., such as remotely controlling the vehicle 14 by an authority, autonomously driving the vehicle 14, semi-autonomously driving the vehicle 14, etc.), and/or revoke authorization of the user's 10 operation of the vehicle 14 and/or user device 10 prior to the journey.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, “communication,” “communicate,” “connection,” “connect,” “call,” “calling,” or other similar terms should generally be construed broadly to mean a wired, wireless, and/or other form of, as applicable, connection between elements, devices, computing devices, telephones, processors, controllers, servers, networks, telephone networks, the cloud, and/or the like, which enable voice and/or data to be sent, transmitted, broadcasted, received, intercepted, acquired, and/or transferred (each as applicable).

As another example, “user,” “first user,” “personnel,” or similar terms should generally be construed broadly to mean a user who is or will be operating a vehicle for a journey.

Also, as referred to herein, a processor, device, computing device, telephone, phone, server, gateway server, communication gateway server, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Database (or memory or storage) may comprise any collection and/or arrangement of volatile and/or non-volatile components suitable for storing data. For example, memory may comprise random access memory (RAM) devices, read-only memory (ROM) devices, magnetic storage devices, optical storage devices, solid state devices, and/or any other suitable data storage devices. In particular embodiments, database may represent, in part, computer-readable storage media on which computer instructions and/or logic are encoded. Database may represent any number of memory components within, local to, and/or accessible by a processor and/or computing device.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method of managing vehicular operational risks, the method comprising:
receiving, by a processor from a mobile device of a first user, a pre-journey information set for a first journey of the first user, the pre-journey information set including:
a start time for the first journey; and
a pre-journey device activity information set, the pre-journey device activity information set including information on usage of the mobile device by the first user during a first time period immediately preceding the start time;
generating, by the processor, an in-journey information set, the in-journey information set including information received, by the processor from the mobile device, at a first time, the first time being a time after the start time, the in information set including:
an in-journey duration information set, the in-journey duration information set including one or more of the following: an amount of time between the start time and the first time, estimated remaining time for the first journey as of the first time, and/or estimated duration for the first journey, wherein the estimated duration for the first journey includes an estimated total travel time for the first journey; and
generating, by the processor, a user operation score for the first user for the first time, the user operation score representing vehicular operational risks of the first user for the first journey as of the first time, the user operation score generated based on at least the pre-journey device activity information set and the in-journey duration information set.

2. The method of claim 1,
wherein the in-journey information set further includes:
an in-journey geolocation information set, the in-journey geolocation information set including present location information as of the first time, estimated distance for the first journey as of the first time, and/or route information for the first journey as of the first time, wherein the estimated distance for the first journey includes an estimated total distance for the first journey as of the first time, wherein the present location information includes geolocation information of the mobile device as of the first time, wherein the route information includes route information for the first journey as of the first time; and
wherein the generating of the user operation score is further based on the in journey geolocation information set.

3. The method of claim 1,
wherein the in journey information set further includes:
an in journey device activity information set, the in journey device activity information set including information on usage of the mobile device by the first user between the start time and the first time; and
wherein the generating of the user operation score is further based on the in journey device activity information set.

4. The method of claim 3, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

5. The method of claim 1,
wherein the pre-journey information set further includes:
a pre-journey biometric information set, the pre-journey biometric information set including biometric information of the first user obtained during a second time period immediately preceding the start time;
wherein the generating of the user operation score for the first user for the first time is further based on the pre-journey biometric information set.

6. The method of claim 1,
wherein the in journey information set further includes:
an in journey biometric information set, the in journey biometric information set including real-time biometric information of the first user and/or biometric information of the first user obtained between the start time and the first time;
wherein the generating of the user operation score for the first user for the first time is further based on the in-journey biometric information set.

7. The method of claim 1,
wherein the in journey information set further includes:
an in journey environmental information set, the in journey environmental information set including real-time weather conditions, real-time traffic conditions, weather conditions between the start time and the first time, traffic conditions between the start time and the first time, weather condition forecasts for the rest of the first journey, and/or traffic condition forecasts for the rest of the first journey;
wherein the generating of the user operation score for the first user for the first time is further based on the in-journey environmental information set.

8. The method of claim 1,
wherein the in journey information set further includes:
an in journey temporal information set, the in journey temporal information set including one or more of the following: the first time, time of the day, day of the week, and/or day of the month;
wherein the generating of the user operation score for the first user for the first time is further based on the in-journey temporal information set.

9. The method of claim 1,
wherein the in journey information set further includes:
an in journey rest information set, the in journey rest information set including rest recommendations for the first user during the first journey based on at least the in-journey duration information set; and
wherein the generating of the user operation score is further based on the in journey rest information set.

10. The method of claim 1,
wherein the pre-journey information set further includes:
a pre-journey hazardous gas information set, the pre-journey hazardous gas information set including information pertaining to a hazardous gas level within a vehicle of the first user obtained during a second time period immediately preceding the start time;
wherein the generating of the user operation score for the first user for the first time is further based on the pre-journey hazardous gas information set.

11. The method of claim 1,
wherein the in journey information set further includes:
an in journey hazardous gas information set, the in journey hazardous gas information set including real-time information pertaining to a hazardous gas level within a vehicle of the first user obtained between the start time and the first time;
wherein the generating of the user operation score for the first user for the first time is further based on the in-journey hazardous gas information set.

12. The method of claim 1,
wherein the in journey information set further includes:
an in journey fuel consumption information set, the in journey fuel consumption information set including real-time information pertaining to fuel consumption of a vehicle of the first user obtained between the start time and the first time;
wherein the generating of the user operation score for the first user for the first time is further based on the in-journey fuel consumption information set.

13. The method of claim 1, further comprising:
responsive to a determination that the user operation score for the first user for the first time is less than or equal to a threshold operation score:
sending a notification to the first user to stop vehicular operations and rest; and/or
sending a notification to an authority regarding potentially unsafe vehicular operations by the first user; and/or
sending a command to shut down vehicular operations.

14. The method of claim 1, further comprising:
generating, by the processor, a second in journey information set, the second in-journey information set including information received, by the processor from the mobile device, at a second time, the second time being a time after the first time, the second in-journey information set including:
a second in journey duration information set, the second in journey duration information set including one or more of the following: an amount of time between the start time and the second time, estimated remaining time for the first journey as of the second time, and/or second estimated duration for the first journey, wherein the second estimated duration for the first journey includes an estimated total travel time for the first journey as of the second time; and
generating, by the processor, a user operation score for the first user for the second time, the user operation score representing vehicular operational risks of the first user for the first journey as of the second time, the user operation score generated based on at least the pre-journey device activity information set and the second in-journey duration information set.

15. The method of claim 2, further comprising:
generating, by the processor, a second in-journey information set, the second in-journey information set including information received, by the processor from the mobile device, at a second time, the second time being a time after the first time, the second in-journey information set including:
a second in-journey geolocation information set, the second in-journey geolocation information set including present location information as of the second time, estimated distance for the first journey as of the second time, and/or route information for the first journey as of the second time, wherein the estimated distance for the first journey includes an estimated total distance for the first journey as of the second time, wherein the present location information includes geolocation information of the mobile device as of the second time, wherein the route information includes route information for the first journey as of the second time; and
generating, by the processor, a user operation score for the first user for the second time, the user operation score representing vehicular operational risks of the first user for the first journey as of the second time, the user operation score generated based on at least the pre-journey device activity information set and the second in-journey geolocation information set.

16. The method of claim 3, further comprising:
generating, by the processor, a second in-journey information set, the second in-journey information set including information received, by the processor from the mobile device, at a second time, the second time being a time after the first time for the first journey, the second in-journey information set including:
a second in-journey device activity information set, the second in journey device activity information set including information on usage of the mobile device by the first user between the start time and the second time; and
generating, by the processor, a user operation score for the first user for the second time, the user operation score representing vehicular operational risks of the first user for the first journey as of the second time, the user operation score generated based on at least the pre-journey device activity information set and the second in-journey device activity information set.

17. The method of claim 9, further comprising:
generating, by the processor, a second in-journey information set, the second in-journey information set including information received, by the processor from the mobile device, at a second time, the second time being a time after the first time for the first journey, the second in-journey information set including:
a second in-journey duration information set, the second in-journey duration information set including one or more of the following: an amount of time between the start time and the second time, estimated remaining time for the first journey as of the second time, and/or second estimated duration for the first journey, wherein the second estimated duration for the first journey includes an estimated total travel time for the first journey as of the second time; and
a second in-journey rest information set, the second in-journey rest information set including rest recommendations for the first user during the first journey based on at least the second in-journey duration information set; and
generating, by the processor, a user operation score for the first user for the second time, the user operation score representing vehicular operational risks of the first user for the first journey as of the second time, the user operation score generated based on at least the pre-journey device activity information set and the second in-journey rest information set.

18. A method of managing vehicular operational risks, the method comprising:
receiving, by a processor from a mobile device of a first user, a pre-journey information set for a first journey of the first user, the pre-journey information set being information received by the processor before the start time, the pre-journey information set including:
a start time for the first journey;
a pre-journey geolocation information set, the pre-journey geolocation information set including a pre-journey estimated distance for the first journey and pre-journey route information for the first journey;
a pre-journey duration information set, the pre-journey duration information set including an estimated total travel time for the first journey; and
a pre-journey device activity information set, the pre-journey device activity information set including information on mobile device usage by the first user during a first time period immediately preceding the start time; and
generating, by the processor, a user operation score for the first user for the start time, the user operation score representing vehicular operational risks of the first user for the first journey as of the start time, the user operation score generated based on at least the pre-journey geolocation information set, the pre-journey duration information set, and the pre-journey device activity information set.

19. The method of claim 18, wherein the pre-journey information set further includes:
a pre-journey rest information set, the pre-journey rest information set including rest recommendations for the first user during the first journey based on at least one or more of the following: the pre-journey estimated distance for the first journey, the pre-journey route information for the first journey, the pre-journey duration information set, and/or the pre-journey device activity information set.

20. The method of claim 18, further comprising:
generating, by the processor, an in-journey information set, the in-journey information set including information received, by the processor from the mobile device, at a first time, the first time being a time after the start time, the in information set including:
an in-journey geolocation information set, the in-journey geolocation information set including an in-journey present location information, in-journey estimated distance for the first journey, and/or in-journey route information for the first journey, wherein the in-journey estimated distance for the first journey includes an update to the pre-journey estimated distance for the first journey as of the first time, wherein the in-journey present location information includes geolocation information of the mobile device as of the first time, wherein the in-journey route information includes an update to the pre-journey route information for the first journey as of the first time; and
generating, by the processor, a user operation score for the first user for the first time, the user operation score representing vehicular operational risks of the first user for the first journey as of the first time, the user operation score generated based on at least the in-journey geolocation information set.

21. The method of claim 18, further comprising:
generating, by the processor, an in-journey information set, the in-journey information set including information received, by the processor from the mobile device, at a first time, the first time being a time after the start time, the in information set including:
an in-journey duration information set, the in-journey duration information set including one or more of the following: an in-journey amount of time between the start time and the first time, in estimated remaining time for the first journey as of the first time, and/or in-journey estimated duration for the first journey, wherein the in-journey estimated duration for the first journey includes an update to the pre-journey duration information set as of the first time; and
generating, by the processor, a user operation score for the first user for the first time, the user operation score representing vehicular operational risks of the first user for the first journey as of the first time, the user operation score generated based on at least the in-journey duration information set.

22. The method of claim 18, further comprising:
generating, by the processor, an in-journey information set, the in-journey information set including information received, by the processor from the mobile device, at a first time, the first time being a time after the start time, the in information set including:
an in-journey device activity information set, the in-journey device activity information set including information on usage of the mobile device by the first user between the start time and the first time; and
generating, by the processor, a user operation score for the first user for the first time, the user operation score representing vehicular operational risks of the first user for the first journey as of the first time, the user operation score generated based on at least the in-journey device activity information set.

23. The method of claim 22, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

24. The method of claim 19, further comprising:
generating, by the processor, an in-journey information set, the in-journey information set including information received, by the processor from the mobile device, at a first time, the first time being a time after the start time, the in information set including:
an in-journey rest information set, the in-journey rest information set including an update to the rest recommendations in the pre-journey rest information set as of the first time; and
generating, by the processor, a user operation score for the first user for the first time, the user operation score representing vehicular operational risks of the first user for the first journey as of the first time, the user operation score generated based on at least the in-journey rest information set.

25. The method of claim 19, further comprising:
generating, by the processor, an in-journey information set, the in-journey information set including information received, by the processor from the mobile device, at a first time, the first time being a time after the start time, the in information set including:
an in-journey geolocation information set, the in-journey geolocation information set including an in-journey present location information, in-journey estimated distance for the first journey, and/or in-journey route information for the first journey, wherein the in-journey estimated distance for the first journey includes an update to the pre-journey estimated distance for the first journey as of the first time, wherein the in-journey present location information includes geolocation information of the mobile device as of the first time, wherein the in-journey route information includes an update to the pre-journey route information for the first journey as of the first time;
an in-journey duration information set, the in-journey duration information set including one or more of the following: an in-journey amount of time between the start time and the first time, in estimated remaining time for the first journey as of the first time, and/or in-journey estimated duration for the first journey, wherein the in-journey estimated duration for the first journey includes an update to the pre-journey duration information set as of the first time;
an in-journey device activity information set, the in-journey device activity information set including information on usage of the mobile device by the first user between the start time and the first time; and
an in-journey rest information set, the in-journey rest information set including an update to the rest recommendations in the pre-journey rest information set as of the first time; and
generating, by the processor, a user operation score for the first user for the first time, the user operation score representing vehicular operational risks of the first user for the first journey as of the first time, the user operation score generated based on at least the in-journey geolocation information set, the in-journey duration information set, the in-journey device activity information set, and the in-journey rest information set.

26. The method of claim 25,
wherein the updates to the rest recommendations are based on one or more of the following: the in-journey estimated distance for the first journey, the in-journey present location information, the in-journey route information for the first journey, the in-journey estimated duration for the first journey, the in-journey estimated remaining time for the first journey, the in-journey amount of time between the start time and the first time, the in-journey device activity information set, and/or an in-journey rests taken information set;
wherein the in-journey rests taken information set include rests taken by the first user between the start time and the first time.

27. The method of claim 25, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

28. The method of claim 25,
wherein the in journey information set further includes:
an in-journey temporal information set, the in-journey temporal information set including one or more of the following: the first time, time of the day, day of the week, and/or day of the month;
wherein the generating of the user operation score for the first user for the first time is further based on the in-journey temporal information set.

29. The method of claim 18,
wherein the pre-journey information set further includes:
a pre-journey hazardous gas information set, the pre-journey hazardous gas information set including information pertaining to a hazardous gas level within a vehicle of the first user obtained during a second time period immediately preceding the start time;
wherein the generating of the user operation score for the first user for the first time is further based on the pre-journey hazardous gas information set.

30. The method of claim 18, further comprising:
generating, by the processor, an in-journey information set, the in-journey information set including information received, by the processor from the mobile device, at a first time, the first time being a time after the start time, the in information set including:
an in-journey hazardous gas information set, the in-journey hazardous gas information set including real-time information pertaining to a hazardous gas level within a vehicle of the first user obtained between the start time and the first time;
generating, by the processor, a user operation score for the first user for the first time, the user operation score representing vehicular operational risks of the first user for the first journey as of the first time, the user operation score generated based on at least the in-journey hazardous gas information set.

31. The method of claim 18, further comprising:
generating, by the processor, an in-journey information set, the in-journey information set including information received, by the processor from the mobile device, at a first time, the first time being a time after the start time, the in information set including:
an in-journey fuel consumption information set, the in-journey fuel consumption information set including real-time information pertaining to fuel consumption of a vehicle of the first user obtained between the start time and the first time;
generating, by the processor, a user operation score for the first user for the first time, the user operation score representing vehicular operational risks of the first user for the first journey as of the first time, the user operation score generated based on at least the in-journey fuel consumption information set.

32. The method of claim 18, further comprising:
responsive to a determination that the user operation score for the first user for the start time is less than or equal to a threshold operation score:
sending a notification to the first user to stop vehicular operations and rest; and/or
sending a notification to an authority regarding potentially unsafe vehicular operations by the first user; and/or
sending a command to shut down vehicular operations.

33. The method of claim 25, further comprising:
responsive to a determination that the user operation score for the first user for the first time is less than or equal to a threshold operation score:
sending a notification to the first user to stop vehicular operations and rest; and/or
sending a notification to an authority regarding potentially unsafe vehicular operations by the first user; and/or
sending a command to shut down vehicular operations.

34. The method of claim 25, further comprising:
generating, by the processor, a second in-journey information set, the second in-journey information set including information received, by the processor from the mobile device, at a second time, the second time being a time after the first time, the second in-journey information set including:
a second in-journey geolocation information set, the second in-journey geolocation information set including a second in-journey present location information, second in-journey estimated distance for the first journey, and second in-journey route information for the first journey, wherein the second in-journey estimated distance for the first journey includes an update to the in-journey estimated distance for the first journey as of the second time, wherein the second in-journey present location information includes geolocation information of the mobile device as of the second time, wherein the second in-journey route information includes an update to the in-journey route information for the first journey as of the second time; and
generating, by the processor, a user operation score for the first user for the second time, the user operation score representing vehicular operational risks of the first user for the first journey as of the second time, the user operation score generated based on at least the second in-journey geolocation information set.

35. The method of claim 25, further comprising:
generating, by the processor, a second in-journey information set, the second in-journey information set including information received, by the processor from the mobile device, at a second time, the second time being a time after the first time for the first journey, the second in-journey information set including:
a second in-journey duration information set, the second in-journey duration information set including one or more of the following: a second in-journey amount of time between the start time and the second time, second in-journey estimated remaining time for the first journey, and/or second in-journey estimated duration for the first journey, wherein the second in-journey estimated duration for the first journey includes an update to the in-journey estimated duration for the first journey as of the second time; and
generating, by the processor, a user operation score for the first user for the second time, the user operation score representing vehicular operational risks of the first user for the first journey as of the second time, the user operation score generated based on at least the second in-journey duration information set.

36. The method of claim 25, further comprising:
generating, by the processor, a second in-journey information set, the second in-journey information set including information received, by the processor from the mobile device, at a second time, the second time being a time after the first time for the first journey, the second in-journey information set including:
a second in-journey device activity information set, the second in-journey device activity information set including information on usage of the mobile device by the first user between the start time and the second time; and
generating, by the processor, a user operation score for the first user for the second time, the user operation score representing vehicular operational risks of the first user for the first journey as of the second time, the user operation score generated based on at least the second in-journey device activity information set.

37. The method of claim 25, further comprising:
generating, by the processor, a second in-journey information set, the second in-journey information set including information received, by the processor from the mobile device, at a second time, the second time being a time after the first time for the first journey, the second in-journey information set including:
a second in-journey rest information set, the second in-journey rest information set including an update to the rest recommendations in the in-journey rest information set as of the second time; and
generating, by the processor, a user operation score for the first user for the second time, the user operation score representing vehicular operational risks of the first user for the first journey as of the second time, the user operation score generated based on at least the second in-journey rest information set.

38. The method of claim 18,
wherein the pre-journey information set further includes:
a pre-journey biometric information set, the pre-journey biometric information set including biometric information of the first user obtained during a second time period immediately preceding the start time;
wherein the generating of the user operation score for the first user for the start time is further based on the pre-journey biometric information set.

39. The method of claim 25,
wherein the in journey information set further includes:
an in journey biometric information set, the in journey biometric information set including real-time biometric information of the first user and/or biometric information of the first user obtained between the start time and the first time;
wherein the generating of the user operation score for the first user for the first time is further based on the in-journey biometric information set.

40. The method of claim 25,
wherein the in journey information set further includes:
an in-journey environmental information set, the in-journey environmental information set including real-time weather conditions, real-time traffic conditions, weather conditions between the start time and the first time, traffic conditions between the start time and the first time, weather condition forecasts for the rest of the first journey, and/or traffic condition forecasts for the rest of the first journey;
wherein the generating of the user operation score for the first user for the first time is further based on the in-journey environmental information set.

41. A method of managing vehicular operational risks, the method comprising:
receiving, by a processor from a mobile device of a first user, a pre-journey information set for a first journey of the first user, the pre-journey information set being information received by the processor before the start time, the pre-journey information set including:
a start time for the first journey;
a pre-journey geolocation information set, the pre-journey geolocation information set including a pre-journey estimated distance for the first journey and pre-journey route information for the first journey;
a pre-journey duration information set, the pre-journey duration information set including an estimated total travel time for the first journey; and
a pre-journey device activity information set, the pre-journey device activity information set including information on mobile device usage by the first user during a first time period immediately preceding the start time; and
generating, by the processor, an in-journey information set, the in-journey information set including information received, by the processor from the mobile device, at a first time, the first time being a time after the start time, the in information set including:
an in-journey geolocation information set, the in-journey geolocation information set including an in-journey present location information, in-journey estimated distance for the first journey, and/or in-journey route information for the first journey, wherein the in-journey estimated distance for the first journey includes an update to the pre-journey estimated distance for the first journey as of the first time, wherein the in-journey present location information includes geolocation information of the mobile device as of the first time, wherein the in-journey route information includes an update to the pre-journey route information for the first journey as of the first time;
an in-journey duration information set, the in-journey duration information set including one or more of the following: an in-journey amount of time between the start time and the first time, in estimated remaining time for the first journey as of the first time, and/or in-journey estimated duration for the first journey, wherein the in-journey estimated duration for the first journey includes an update to the pre-journey duration information set as of the first time;
an in-journey device activity information set, the in-journey device activity information set including information on usage of the mobile device by the first user between the start time and the first time; and
an in-journey rest information set, the in-journey rest information set including rest recommendations for the first user during the first journey based on at least one or more of the following: the in-journey present location information, the in-journey estimated distance for the first journey, the in-journey route information for the first journey, the in-journey duration information set, and/or the in-journey device activity information set; and
generating, by the processor, a user operation score for the first user for the first time, the user operation score representing vehicular operational risks of the first user for the first journey as of the first time, the user operation score generated based on at least the in-journey geolocation information set, the in-journey duration information set, the in-journey device activity information set, and the in-journey rest information set.

42. The method of claim 41, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

43. The method of claim 41,
wherein the rest recommendations are based on one or more of the following: the in-journey estimated distance for the first journey, the in-journey present location information, the in-journey route information for the first journey, the in-journey estimated duration for the first journey, the in-journey estimated remaining time for the first journey, the in-journey amount of time between the start time and the first time, the in-journey device activity information set, and/or an in-journey rests taken information set;
wherein the in-journey rests taken information set include rests taken by the first user between the start time and the first time.

44. The method of claim 41, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

45. The method of claim 41,
wherein the in-journey information set further includes:
an in-journey temporal information set, the in-journey temporal information set including one or more of the following: the first time, time of the day, day of the week, and/or day of the month;
wherein the generating of the user operation score for the first user for the first time is further based on the in-journey temporal information set.

46. The method of claim 41,
wherein the pre-journey information set further includes:
a pre-journey hazardous gas information set, the pre-journey hazardous gas information set including information pertaining to a hazardous gas level within a vehicle of the first user obtained during a second time period immediately preceding the start time;
wherein the generating of the user operation score for the first user for the first time is further based on the pre-journey hazardous gas information set.

47. The method of claim 41,
wherein the in-journey information set further includes:
an in-journey hazardous gas information set, the in-journey hazardous gas information set including real-time information pertaining to a hazardous gas level within a vehicle of the first user obtained between the start time and the first time;
wherein the generating of the user operation score for the first user for the first time is further based on the in-journey hazardous gas information set.

48. The method of claim 41,
wherein the in-journey information set further includes:
an in-journey fuel consumption information set, the in-journey fuel consumption information set including real-time information pertaining to fuel consumption of a vehicle of the first user obtained between the start time and the first time;
wherein the generating of the user operation score for the first user for the first time is further based on the in-journey fuel consumption information set.

49. The method of claim 41, further comprising:
responsive to a determination that the user operation score for the first user for the first time is less than or equal to a threshold operation score:
sending a notification to the first user to stop vehicular operations and rest; and/or
sending a notification to an authority regarding potentially unsafe vehicular operations by the first user; and/or
sending a command to shut down vehicular operations.

50. A method of managing vehicular operational risks, the method comprising:
receiving, by a processor from a mobile device of a first user, a start time for a first journey of the first user;
generating, by the processor, an in-journey information set, the in-journey information set including information received, by the processor from the mobile device, at a first time, the first time being a time after the start time, the in information set including:
an in-journey geolocation information set, the in-journey geolocation information set including an in-journey present location information, in-journey estimated distance for the first journey, and/or in-journey route information for the first journey, wherein the in-journey present location information includes geolocation information of the mobile device as of the first time;
an in-journey duration information set, the in-journey duration information set including one or more of the following: an in-journey amount of time between the start time and the first time, in estimated remaining time for the first journey as of the first time, and/or in-journey estimated duration for the first journey, wherein the in-journey estimated duration for the first journey includes an estimated total travel time for the first journey;
an in-journey device activity information set, the in-journey device activity information set including information on usage of the mobile device by the first user between the start time and the first time; and
an in-journey rest information set, the in-journey rest information set including rest recommendations for the first user during the first journey based on at least one or more of the following: the in-journey present location information, the in-journey estimated distance for the first journey, the in-journey route information for the first journey, the in-journey duration information set, and/or the in-journey device activity information set; and
generating, by the processor, a user operation score for the first user for the first time, the user operation score representing vehicular operational risks of the first user for the first journey as of the first time, the user operation score generated based on at least the in-journey geolocation information set, the in-journey duration information set, the in-journey device activity information set, and the in-journey rest information set.

51. The method of claim 50, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

52. The method of claim 50,
wherein the rest recommendations are based on one or more of the following: the in-journey estimated distance for the first journey, the in-journey present location information, the in-journey route information for the first journey, the in-journey estimated duration for the first journey, the in-journey estimated remaining time for the first journey, the in-journey amount of time between the start time and the first time, the in-journey device activity information set, and/or an in-journey rests taken information set;
wherein the in-journey rests taken information set include rests taken by the first user between the start time and the first time.

53. The method of claim 50, wherein the information on usage of the mobile device by the first user between the start time and the first time includes one or more of the following: information pertaining to total screen time, types of applications used, gestures received by the first user, type of content in applications used by the first user, extent of usage of each application used, whether the mobile device is operating on a split-screen basis, a network activity score, an orientation change score, camera usage, microphone usage, and/or speaker usage.

54. The method of claim 50,
wherein the in-journey information set further includes:
an in-journey temporal information set, the in-journey temporal information set including one or more of the following: the first time, time of the day, day of the week, and/or day of the month;
wherein the generating of the user operation score for the first user for the first time is further based on the in-journey temporal information set.

55. The method of claim 50,
wherein the in-journey information set further includes:
an in-journey hazardous gas information set, the in-journey hazardous gas information set including real-time information pertaining to a hazardous gas level within a vehicle of the first user obtained between the start time and the first time;
wherein the generating of the user operation score for the first user for the first time is further based on the in-journey hazardous gas information set.

56. The method of claim 50,
wherein the in-journey information set further includes:
an in-journey fuel consumption information set, the in-journey fuel consumption information set including real-time information pertaining to fuel consumption of a vehicle of the first user obtained between the start time and the first time;
wherein the generating of the user operation score for the first user for the first time is further based on the in-journey fuel consumption information set.

57. The method of claim 50, further comprising:
responsive to a determination that the user operation score for the first user for the first time is less than or equal to a threshold operation score:
sending a notification to the first user to stop vehicular operations and rest; and/or
sending a notification to an authority regarding potentially unsafe vehicular operations by the first user; and/or
sending a command to shut down vehicular operations.
